(19) United States
(12) Patent Application Publication
(10) Pub. No.: US 2012/0185409 A1
(43) Pub. Date: Jul. 19, 2012

(54) Systems and Methods for Securitizing the Revenue Stream of a Product

(75) Inventors: Timothy P. Coleman, Wellesley, MA (US); Jeffrey C. Heisler, Needham, MA (US)

(73) Assignee: Furrow LLC

(21) Appl. No.: 13/287,758

(22) Filed: Nov. 2, 2011

Related U.S. Application Data
(60) Provisional application No. 61/409,396, filed on Nov. 2, 2010.

(51) Int. Cl. G06Q 40/06

(52) U.S. Cl. 705/36 R

(57) ABSTRACT

Systems and methods for securitizing the revenue stream of a product are disclosed. A system for securitizing the revenue stream of a product includes a primary market allowing a company to sell a percentage of the revenue of a product of the company to an investor, wherein the percentage of revenue stake in the product comprises issued shares; the bundling of the issued shares into various investment products; a secondary market providing liquidity for issued or bundled shares allowing the investor to trade these shares or bundles; retail market where these sales take place; wherein a transfer of the issued share from the company to the investor provides financial capital for the company without relinquishing an ownership stake in the company itself, and wherein when the product is sold, the investor is entitled to a percentage of revenues generated by sales of the product according to the issued shares.

### RELATED APPLICATIONS

This application claims the benefit of and priority to U.S. Provisional Patent Application No. 61/409,396, filed on Nov. 2, 2010, the entirety of this application is hereby incorporated herein by reference for the teachings therein.

### FIELD

The embodiments disclosed herein relate to systems and methods for raising financial capital, and more particularly to systems and methods for raising financial capital by securitizing the revenue stream of a product.

### BACKGROUND

Some business models, like application development for smart phones and other devices, have smaller capital requirements in bringing a revenue generating product to the market because a considerable amount of the potential risk is assumed by the entrepreneur. This means, however, that these businesses may not be well suited for raising traditional capital (i.e. bonds and stocks). Angel or Venture Capital financing involves selling a (potentially large) ownership stake of the underlying equity, which can mean either expensive financing or a limit on the ability to raise additional capital. Individual investors are well suited to fund smaller businesses, having the resources to produce a large number of smaller investments, but are too dispersed for efficiently raising capital.

### SUMMARY

Systems and methods for raising financial capital by securitizing the revenue stream of a product are disclosed herein. According to aspects illustrated herein, there is provided a system for securitizing the revenue stream of a product includes a product; a primary market for auctioning ownership percentage of the revenues of a product at a first price, wherein the percentage of revenue interest is a security that entitles a holder of the security to a percentage of the revenue stream of the product; and a secondary market for transforming the ownership interest in the product from an illiquid asset into a liquid asset by allowing the holder of the security to trade the security at a second price.

According to aspects illustrated herein, there is provided a system for raising financial capital by securitizing the revenue stream of a product that includes a primary market that allows a company to sell a percentage of the revenue of a product to an investor, wherein the revenue share in the product comprises issued AppShares; a secondary market for providing liquidity to the issued AppShares that allows the investor to trade the issued AppShares; and wherein a transfer of the issued AppShares from the company to the investor provides financial capital for the company without relinquishing an ownership stake in the company itself, and wherein when the product is sold in retail markets, the investor is entitled to a percentage of revenues generated by sales of the product according to the issued AppShares. There also are the methods of combining a collection of App Shares into one or more investment company entities to trade based on the aggregate revenue stream of the collected AppShares (also known as an “AppBundle”).

According to aspects illustrated herein, there is provided a method for raising financial capital by securitizing the revenue stream of a product (or basket of products) includes providing a primary market that allows a company to sell a percentage of the revenues by a product of the company to investors, wherein the percentage of the revenues in the product comprises issued AppShares; issuing AppShares entitling the investor holding the AppShares to a percentage of revenues generated by sales of the product underlying the issued AppShares; auctioning the AppShares to the investor at a first price; transferring the AppShares from the company to the investor in exchange for financial capital equivalent to the first price multiplied by a number of issued AppShares transferred; providing a secondary market for providing liquidity to the issued AppShares that allows the investor to trade the issued AppShares at a second price; establishing a custodian for maintaining ownership of records identifying the investor holding the issued AppShares purchased at the first price or the second price; distributing the percentage of revenues generated by sales of the application (“App”) to the custodian for safe keeping until a dividend is distributed; distributing the dividend to the investor holding the issued AppShares from the custodian based on a number of the issued AppShares held by the investor; wherein the transfer of the issued AppShares from the company to the investor provides financial capital for the company without relinquishing an ownership stake in the company itself; and wherein the issued AppShares traded at the second price provides a price signal for the efficient allocation of capital.

AppShares are a unique and entirely novel type of financial instrument in that they securitize the revenues of a company's product. AppShares are not: a debt of the company, as opposed to a bond, loan, commercial paper, or other fixed income security; an ownership stake in the company, as opposed to equity securities; a derivative contract; or a factoring transaction, as AppShares do not bear credit risk. AppShares from different products can be indexed and/or bundled as portfolios.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 is a chronological schematic illustration of an embodiment of a system for raising financial capital of the present disclosure.

FIG. 2 is an infrastructure schematic illustration of an embodiment of a system for raising financial capital of the present disclosure.

FIG. 3 is a block diagram illustrating a process for a developer to set-up an account in accordance with an embodiment of a system for raising financial capital of the present disclosure.

FIG. 4 is a block diagram illustrating a process for generating a prospectus in accordance with an embodiment of a system for raising financial capital of the present disclosure.

FIG. 5 is a block diagram illustrating a process for an investor to set-up an account in accordance with an embodiment of a system for raising financial capital of the present disclosure.

FIG. 6 is a block diagram illustrating functions performed by a pricing tool in accordance with an embodiment of a system for raising financial capital of the present disclosure.

FIG. 7 is a block diagram illustrating functions performed by a scheduling tool in accordance with an embodiment of a system for raising financial capital of the present disclosure.

FIG. 8 is a block diagram illustrating functions performed by a matching tool in accordance with an embodiment of a system for raising financial capital of the present disclosure.

FIG. 9 is a chart illustrating various components of an architecture used to implement a system for raising financial capital over a computer network according to an embodiment of a system of the present disclosure.

FIG. 10 is a schematic illustration of an initial network topology in accordance with an embodiment of a system for raising financial capital of the present disclosure.

FIG. 11 is a schematic illustration of a network topology managing an increased load in accordance with an embodiment of a system for raising financial capital of the present disclosure.

FIG. 12 is a schematic illustration of a network topology geographic distribution in accordance with an embodiment of a system for raising financial capital of the present disclosure.

FIG. 13 is a screen shot showing an investor account creation website page in accordance with an embodiment of a system for raising financial capital of the present disclosure.

FIG. 14 is a screen shot showing an investor dashboard website page in accordance with another embodiment of a system for raising financial capital of the present disclosure.

FIG. 15 is a screen shot showing a developer dashboard website page in accordance with an embodiment of a system for raising financial capital of the present disclosure.

FIG. 16 is a screen shot showing an online form for submitting a prospectus in accordance with an embodiment of a system for raising financial capital of the present disclosure.

FIG. 17 is a chart illustrating an auction schedule in accordance with an embodiment of a system for raising financial capital of the present disclosure.

FIG. 18 is a block diagram illustrating a process for generating an electronic road show in accordance with an embodiment of a system for raising financial capital of the present disclosure.

FIG. 19 is a screen shot showing an online form for generating an electronic road show in accordance with an embodiment of a system for raising financial capital of the present disclosure.

FIG. 20 is a block diagram illustrating a process for executing an online auction in accordance with an embodiment of a system for raising financial capital of the present disclosure.

FIG. 21 is a block diagram illustrating functions performed by the online auction tool in accordance with an embodiment of a system for raising financial capital of the present disclosure.

FIG. 22 is a screen shot showing an investor online auction application in accordance with an embodiment of a system for raising financial capital of the present disclosure.

FIG. 23 is a block diagram illustrating functions performed by an online trading application in accordance with an embodiment of a system for raising financial capital of the present disclosure.

FIG. 24 is a screen shot showing an online trading application in accordance with an embodiment of a system for raising financial capital of the present disclosure.

FIG. 25 is a block diagram illustrating an order entry error checking process in accordance with an embodiment of a system for raising financial capital of the present disclosure.

FIG. 26 is a block diagram illustrating an order entry error checking process in accordance with another embodiment of a system for raising financial capital of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The systems and methods described below with reference to block diagrams and operational illustrations of methods and devices to raising financial capital by securitizing the revenue stream of a product. It is understood that each block of the block diagrams or operational illustrations, and combinations of blocks in the block diagrams or operational illustrations, can be implemented by means of analog or digital hardware and computer program instructions. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

Various implementations of the systems and techniques described here can be realized in digital electronic circuitry, integrated circuitry, specially designed ASICs (application-specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device. Such computer programs (also known as programs, software, software applications or code) may include machine instructions for a programmable processor, and may be implemented in any form of programming language, including high-level procedural and/or object-oriented programming languages, and/or in assembly/machine languages. A computer program may be deployed in any form, including as a stand-alone program, or as a module, component, subroutine, or other unit suitable for use in a computing environment. A computer program may be deployed to be executed or interpreted on one computer or on multiple computers at one site, or distributed across multiple sites and interconnected by a communication network.

Reference in this specification to “an embodiment” or “an embodiment” or “some embodiments” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments, but not other embodiments.

For the purposes of this disclosure, the term “server” should be understood to refer to a service point that provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure, the term “app” and/or “App” should be understood to refer to a computer executable module comprising application software designed to help users to perform specific tasks. Apps may be bundled with a computing and its system software, or may be published separately. A typical example of one type of app are mobile apps, designed to run on smartphones and tablet computers.

For the purposes of this disclosure, a computer-readable medium stores computer data, which data can include computer program code that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM (random access memory), ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Systems and methods for raising financial capital by securitizing the revenue stream of a product are disclosed herein. In an embodiment, a system for raising financial capital by securitizing the revenue stream of a product includes a primary market, a bundled “market-basket” of products, and a secondary market, wherein the primary and secondary market allow individual entrepreneurs and companies to efficiently raise and allocate development capital by selling a percentage of a product's revenue rather than an ownership stake in the company. In an embodiment, the systems disclosed herein create a primary market that securitizes revenues, and a secondary market for trading those securitized revenues, for software applications (“Apps”). In an embodiment, the systems disclosed herein provide a marketplace for financial instruments, i.e. AppShares, that allows for the electronic transfer of funds and supports a new type of financial instrument and revenue stream model that links entrepreneurs with investors, which can then be extended beyond the App market.

In an embodiment, a system for raising and trading financial capital by securitizing a revenue stream of a product through the issuance of AppShares is known as Boston Electronic Application Network (BEAN). In an embodiment, BEAN is a software application comprising the Auction BEAN and Trading BEAN that allow individual entrepreneurs and companies to efficiently raise and allocate development capital. Auction BEAN is primary market where the AppShares are first priced and issued. AppShares are issued through a closed second price auction and allow more of the proceeds from the auction to flow to the issuer. Trading BEAN is the market where previously issued AppShares are traded. AppShares are traded through an open limit order book. In an embodiment, Trading BEAN provides a liquid marketplace that allows for the consolidation and matching of potential buyers with sellers and is designed to provide intrinsic price signals for the efficient allocation of capital across the App development market.

In an embodiment, a system of the present disclosure is different from traditional markets in that it is designed to maximize transparency while minimizing potential conflicts of interest through disintermediation. Potential conflicts exist whenever an agent or intermediary is required. Allowing developers and investors direct access to the primary, bundled and secondary markets removes this intermediary layer. Transparency means that developers and investors have more information about the state of the market, including prices and order flow. The combination of direct access and greater transparency should allow developers and investors to make informed decisions to maximize value to themselves; producing prices that better reflect their expectations and resulting in a more effective and efficient market. Direct access also means one less layer of fees, meaning that more of the proceeds from the initial public offering of AppShares will flow to the developers and more of trading revenues will flow to investors. A system for raising financial capital by securitizing the revenue stream of a product may be advantageous for a number of reasons, including, but not limited to providing a primary market for newly issued AppShares rather than only trading previously issued assets.

AppShares are a unique financial instrument in that they provide a fixed or variable income stream of revenues of a company's product and are not: a debt security, as they are not a contract outlining the repayment schedule of coupon and principal; an equity security, as they do not represent an ownership stake in the company or the product; a derivative contract, as they are not finite lived, with defined expiration, whose value is derived from the price of another security; a factoring transaction, as they are not a sale of accounts receivables and do not bear the credit risk of the purchaser. AppShares are different from other existing revenue based derivative contracts in that they are not finite lived, provide a security that does not have limited revenue participation, provide a security that produces a dividend stream derived from the sales of a product, and provide a security that does not allow for short positions or leverage. In addition, while the presentation of the embodiment of the system for raising capital by selling a percentage of a product's revenue focuses on Apps and App developers, AppShares and the system can be applied to any product. These products can be any item, e.g., manufactured or intellectual property that can generate revenue by sale and distribution through either retail or commercial markets.

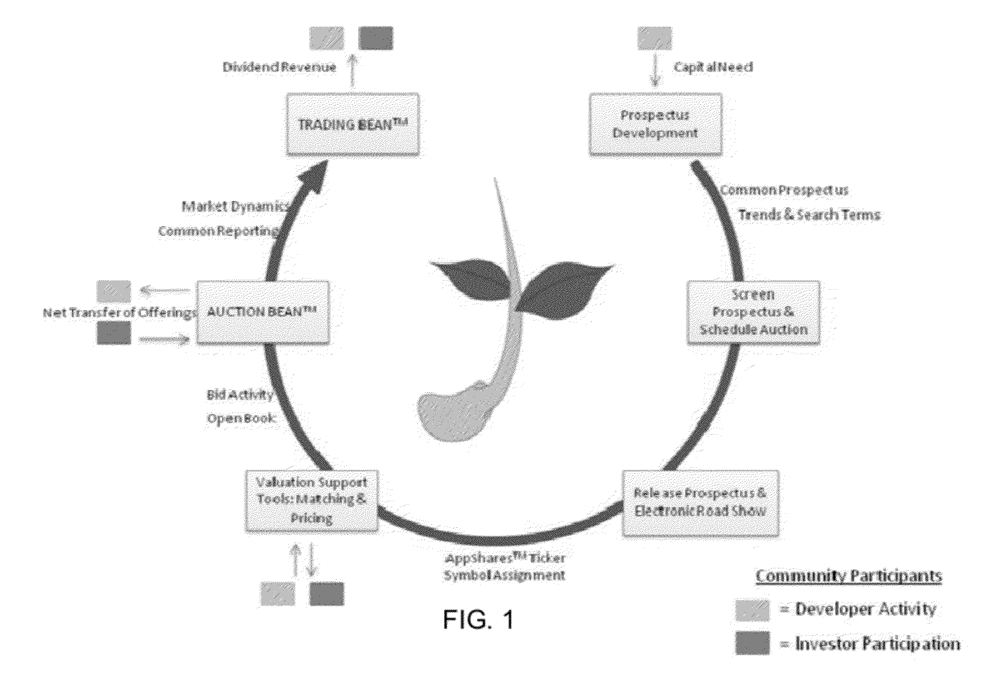

FIG. 1 illustrates the chronological flow of a system for raising financial capital of the present disclosure. As shown in FIG. 1, Prospectus Development: A developer seeking capital completes and submits an electronic prospectus to BEAN; Screen Prospectus & Schedule Auction: After screening for accuracy and completeness, the prospectus is accepted and an auction is scheduled; Release Prospectus and Electronic Roadshow: The prospectus is then made publicly available, along with additional materials, providing investors an opportunity to become familiar with the App; Valuation Support Tools: Matching & Pricing: The support tools provide developers and investors tools to determine a suitable price for the AppShares and identify complimentary and/or comparable Apps; Auction BEAN: The primary market where the AppShares are first priced and issued; Trading BEAN: The secondary market where previously issued AppShares are traded.

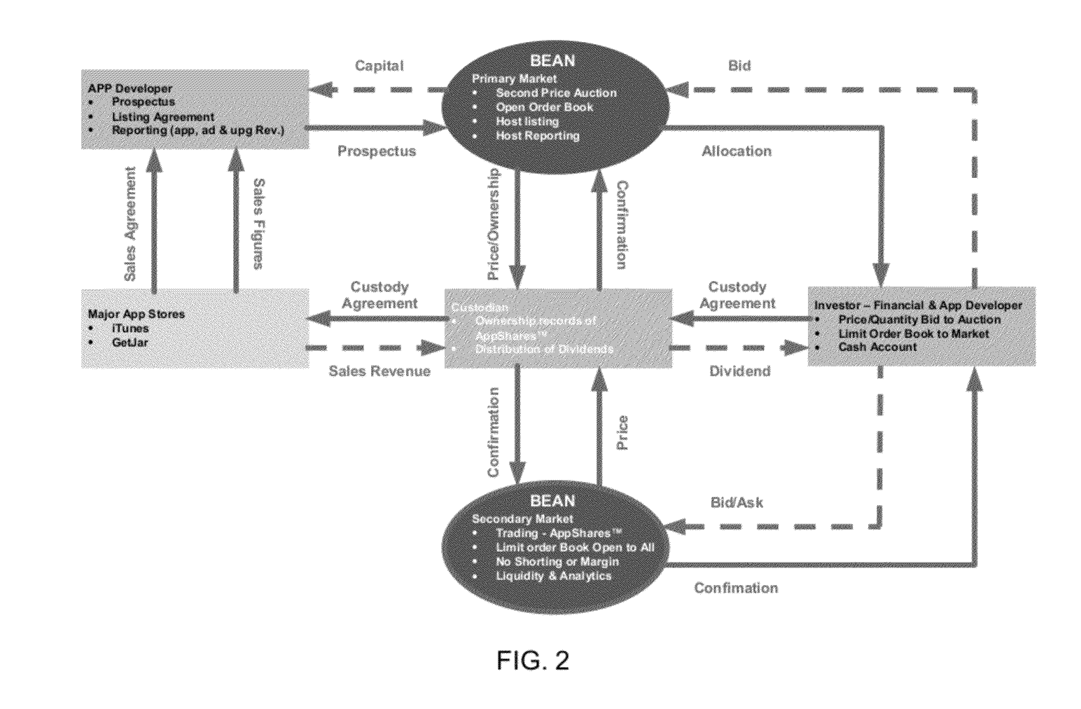

In an embodiment, a system of the present disclosure includes an electronic application network marketplace for raising financial capital by securitizing the revenue stream of a product. FIG. 2 shows an embodiment of the electronic application network marketplace. As shown in FIG. 2, solid lines indicate information flow while the broken lines indicate cash flow. In an embodiment, the electronic application network marketplace includes a primary market, a secondary market, a retail market, a company, an investor, a custodian, and tools for maximizing transparency while simplifying the process of raising financial capital. In an embodiment, the company is a developer of software applications for various platforms. In an embodiment, the retail market is a market for selling Apps.

In an embodiment, a system of the present disclosure includes a primary market. In an embodiment, the primary market provides a means to bring fragmented capital providers together with entrepreneurs. In an embodiment, a system of the present disclosure allows companies to sell stakes in their product's revenues rather than their business, aligning investors and entrepreneurs in the mutually beneficial goal of driving product sales. Such a structured investment product allows entrepreneurs to retain greater control of their company while raising the capital required to further develop current and new products. In an embodiment, the primary market allows a company to sell a percentage of the revenues of a product of the company rather than an ownership stake in the company itself or the product, wherein the percentage of revenue in the product comprises issued AppShares entitling a holder of the issued AppShares to a percentage of revenues generated by sales of the product. In an embodiment, the product is an application developed by the company. In an embodiment, the product is a software application. In an embodiment, the primary market includes a developer of a product. In an embodiment, the developer is an App developer. The App developer, who is already selling an App on any App platform, can raise capital by selling AppShares. AppShares are a revenue sharing agreement which entitle the owner to a percentage of revenues generated by the underlying App across all platforms. AppShares are issued through a closed second price auction through the primary market. In an embodiment, the primary market includes investors. Investors can buy newly issued AppShares in the primary market or trade previously issued AppShares in the secondary market or bundled investment company products called AppBundles.

In an embodiment, a system of the present disclosure includes a secondary market. In an embodiment, the secondary market provides a market to trade the issued AppShares. In an embodiment, the issued AppShares comprise AppShares. In an embodiment, the secondary market for trading issued AppShares provides a liquid market for investors and an intrinsic price signal for the efficient allocation of capital across the App development market. Prices reflect expectations about cash flow for products, providing companies and investors information about where to extend future effort and capital. In an embodiment, the secondary market is provided for transforming an interest in a revenue stream generated by a product (or bundle of product) purchased at a first price by an investor from an illiquid asset into a liquid asset by allowing the holder of an AppShare to trade the instrument at a second price. A security is considered liquid if it can be sold in reasonable quantity and in a timely manner without causing a significant movement in the security's price. The secondary market provides holders of AppShares a single location where they can meet, regardless of location or time, to electronically to buy and sell AppShares. That is, the Trading BEAN creates a marketplace that allows for the consolidation and matching of potential buyers with sellers.

In an embodiment, a system of the present disclosure for raising financial capital by securitizing the revenue stream of a product includes an architecture for delivering a system of the present disclosure for raising financial capital by securitizing the revenue stream of a product. In an embodiment, the system architecture is designed to be secure and robust, with network implementation designed to provide high availability, fault tolerance, and failover capabilities to ensure transaction integrity. In an embodiment, the architecture is modular and scalable, and will support integration to external resources via web services APIs to external resources where required. In an embodiment, the architecture has appropriate redundancy in servers, security algorithms and access points that will be the hardware used to maintain the system. In an embodiment, a downloadable program can be downloaded onto a community participant's personal computing device where the community participants can also access the system. In an embodiment, access control and rights management is also delivered, and a database architecture supports detailed data mining of marketing dynamics and reporting requirements.

In an embodiment, the retail market is for selling the products underlying the issued AppShares. In an embodiment, the retail market for selling Apps is an App Store. App Stores offer the Apps for sale and agree to forward revenues to a custodian for distribution as dividends to AppShares holders. As used herein, “retail” is used in the traditional sense of the sale of goods or merchandise either from a physical or electronic locations. In particular, Apps can be purchased from App stores or other software distribution platforms.

In an embodiment, the custodian acts as a record keeper of AppShares ownership to ensure proper distribution of dividends. In an embodiment, the custodian is a third-party custodian.

In an embodiment, a system of the present disclosure provides tools to investors and developers that promote ease of use and transparency, for example, a search and matching tool to link investors with applications and developers that fit a particular profile.

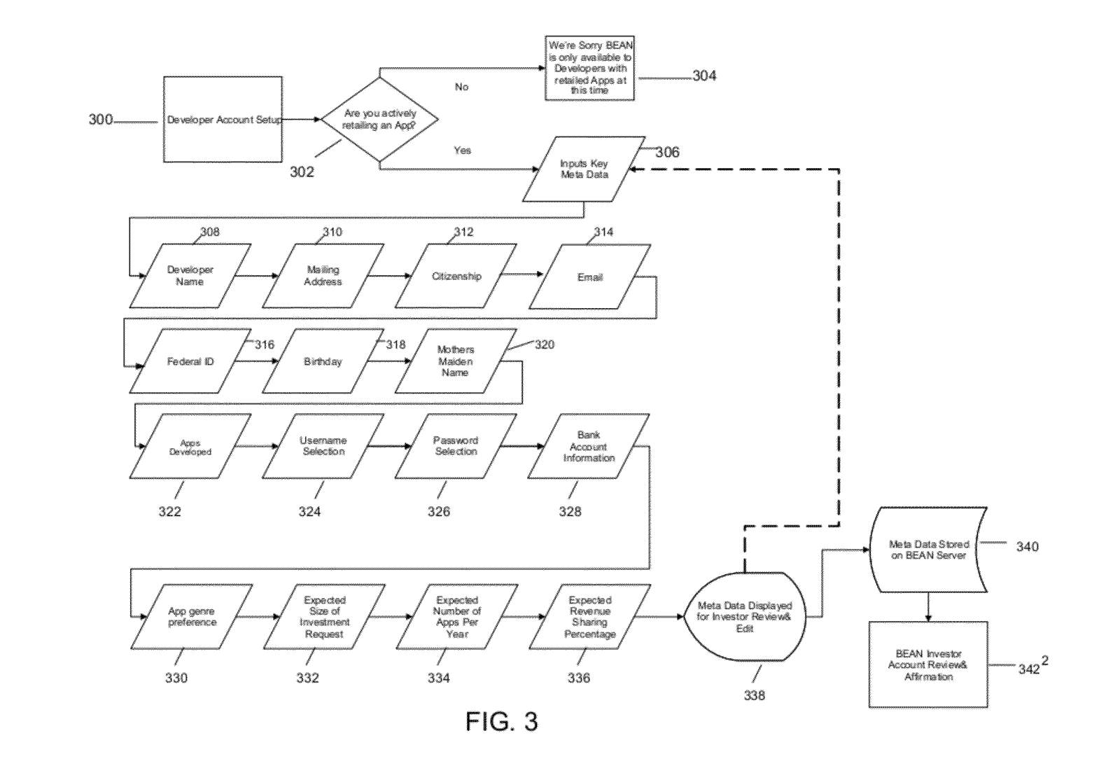

In an embodiment, a system of the present disclosure for raising financial capital by securitizing the revenue stream of a product includes a developer account set-up process. In an embodiment, the developer account set-up process is an automated process. FIG. 3 shows an embodiment of the developer account set-up processes 300. The process provides a standardized format for capturing the information necessary to determine if the developer meets the listing requirements and to ensure the information necessary for security, accuracy and compliance with applicable laws and regulations. It is first determined if the developer meets minimum criteria 302—in one embodiment, the developer must be retailing an App or other computer executable module. If the developer does not meet minimum criteria 304, the developer is asked to come back when they meet such criteria. If the developer meets minimum criteria, the developer is allowed to create an account 306. Various types of data and metadata relating to the developer are then collected (e.g. via interactive questions/prompts) including:
Developer name 308.
Developers mailing address 310.
Developer's country of citizenship 312.
Developers email address 314.
Federal identification number 316 to be used for tax purposes (e.g. EIN, SSN).
Birthday of developer 318—used in security protocols.
Mother's maiden name 320—used for security protocols.
Name(s) of Apps developed 322.
Selection of a username 324.
Selection of an account password 326.
Developer's bank account 328 or PayPal account that the developer will use for transacting business.
A preference of an App genre 330 for which the developer develops commercial Apps.

The developer is then asked 332 how much investment they expect to require to continue developing an App franchise (i.e. version 2, 3, 4, etc.). The developer then provides the expected numbers of Apps the developer expects to release per year 334 and the expected amount of revenue the developer is willing to share with investors. Data collected during the process 308-336 are then displayed to the developer for review and correction 338, if necessary. Finally the system accepts the developer data into a storage configuration of the system 340, associates the developer information with a developer account, and sends a message to the developer that the developer's account is now available 342.

In an embodiment, a system for raising financial capital includes a prospectus. In an embodiment, the prospectus is a common prospectus. The common prospectus provides investors with the information necessary to understand the App's technical, market, and financial specifications so they can make an informed decision. In an embodiment, the common prospectus is designed to create a user friendly document. In an embodiment the common prospectus is simple, in plain English, provides full transparency, and is standardized. In an embodiment, the common prospectus provides an investor with information. In an embodiment, the information provided by the common prospectus includes:
Application or product type—check box: verified at submission.
Description—text.
Name of application—text.
Smartphone Platforms or other sales channel—check box: verified at submission.
Price of product in retail market, pricing for each channel expected—real: verified at submission.
Revenue—real: verified at submission.
Developer name—text.
Warrants and representations—check box acknowledgement of terms. The developer warrants that the App is theirs and they have the right to sell a percentage of the revenues.
Disclosures—boiler plate that is complete and straightforward.
   Risks—there are no guarantees and you should expect to lose all of the money you invest;
   Not equity—you do not own a company or a product, you own a percentage of the revenues generated by a particular App. Therefore, you have no say in how the company is run, how the App evolves or what future Apps are developed;
   Warrants—some information is verified (as indicated) but some is provided by the developer and may be inaccurate. BEAN holds no opinion on the App itself, BEAN has not tested the App and makes no claims as to the quality or potential of the App; previous App revenue is not indicative of future App revenue. Apps are different and market conditions change.

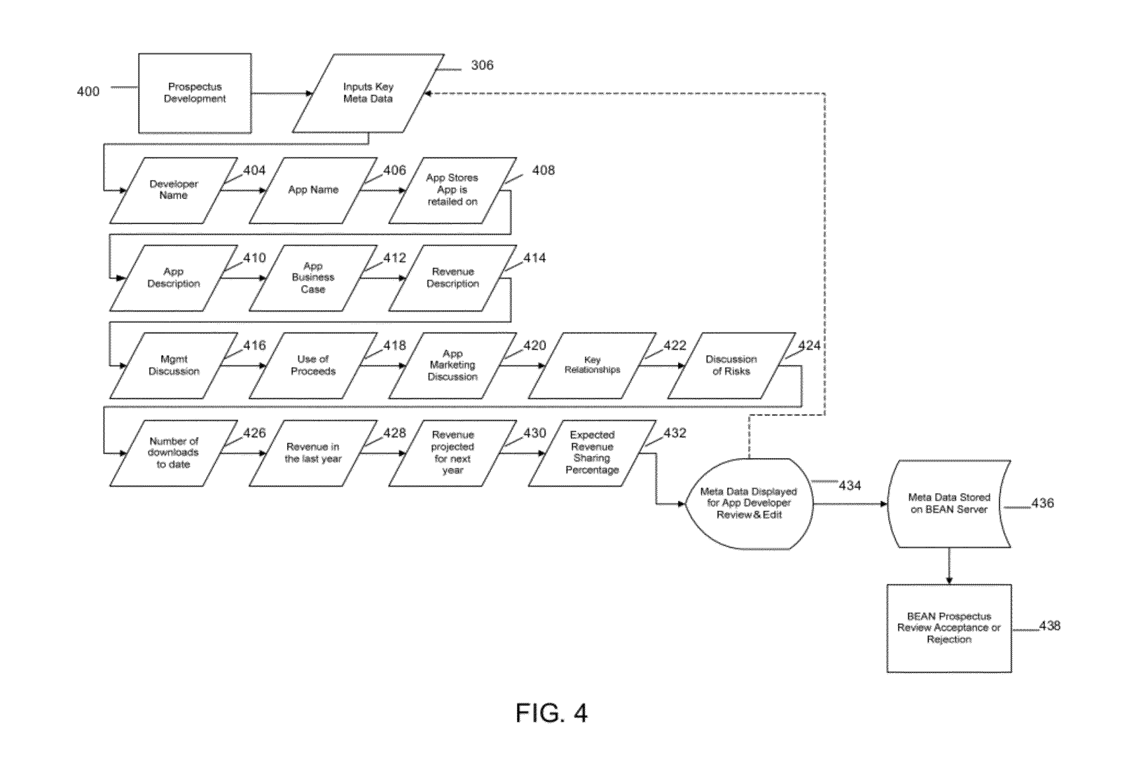

FIG. 4 shows a process 400 for completing the common prospectus. The process 400 provides a means for an App developer to articulate the commercial merit of the App for which they are seeking investment via revenue sharing. Various types of data and metadata relating to the prospectus are collected via the system 306 (e.g. via interactive questions/prompts) including:
Developer name 404.
Name of App 406 for which the developer is offering to share a portion of the revenues.
The name of the App stores 408 that the offered App currently retails within.
A written description of the App 410.
Description of the App's business case 412 (e.g. a business model for the App, prospective customers for the App and so forth).
Description of the sources of revenue 414 that offered App generates (direct sales, indirect sales, advertising etc.).
Written description of the management team 416 involved with the offered App.
Written description of how the invested proceeds will be used to build the offered App franchise 418.
Written description of the marketing plan 420 for the offered App.
Written descriptions of key relationships 422 that support the development of the offered App franchise (i.e. accountant, lawyer, banker, other investors etc.).
Written description of the risks 424 associated with the offered App.
Description of the number of downloads 426 from each store that retails the offered App.
Amount of revenue generated last year 428 by the offered App.
Estimate of revenue expected in the next year 430 for the offered App.
Estimated percentage of revenue 432 the developer expects to offer.

Data collected during the process 404-432 are then displayed 434 to the developer for review and correction if necessary. The system then accepts the developer prospectus data into the system's storage configuration 436. The system then reviews the prospectus data, and sends a message to the developer that the developer's prospectus is accepted or is rejected 438.

In an embodiment, a system of the present disclosure for raising financial capital by securitizing the revenue stream of a product includes reporting. In an embodiment, reporting occurs on a predetermined schedule. In an embodiment, reporting is expected to take the form of an annual report that is designed to be extremely user friendly and provide current and accurate information about the status of the App in the market, e.g., revenues, platforms, comparables, developer discussion. In an embodiment, the reporting comprises an e-report. In an embodiment, the e-reports are hosted on the electronic application network.

In an embodiment, a system of the present disclosure for raising financial capital includes a listing function for listing new AppShares to be issued. In an embodiment, the listing function is known as Auction BEAN. In an embodiment, AppShares are offered to the investor community using a modified second price auction which is transacted using the Auction BEAN. The Auction BEAN will allow investors to allocate AppShares and capital depending upon their desired allotment. Once the auction occurs the AppShares will be available for secondary trade on the secondary market. In an embodiment, the secondary market is an electronic market for trading the auctioned AppShares known as the Trading BEAN.

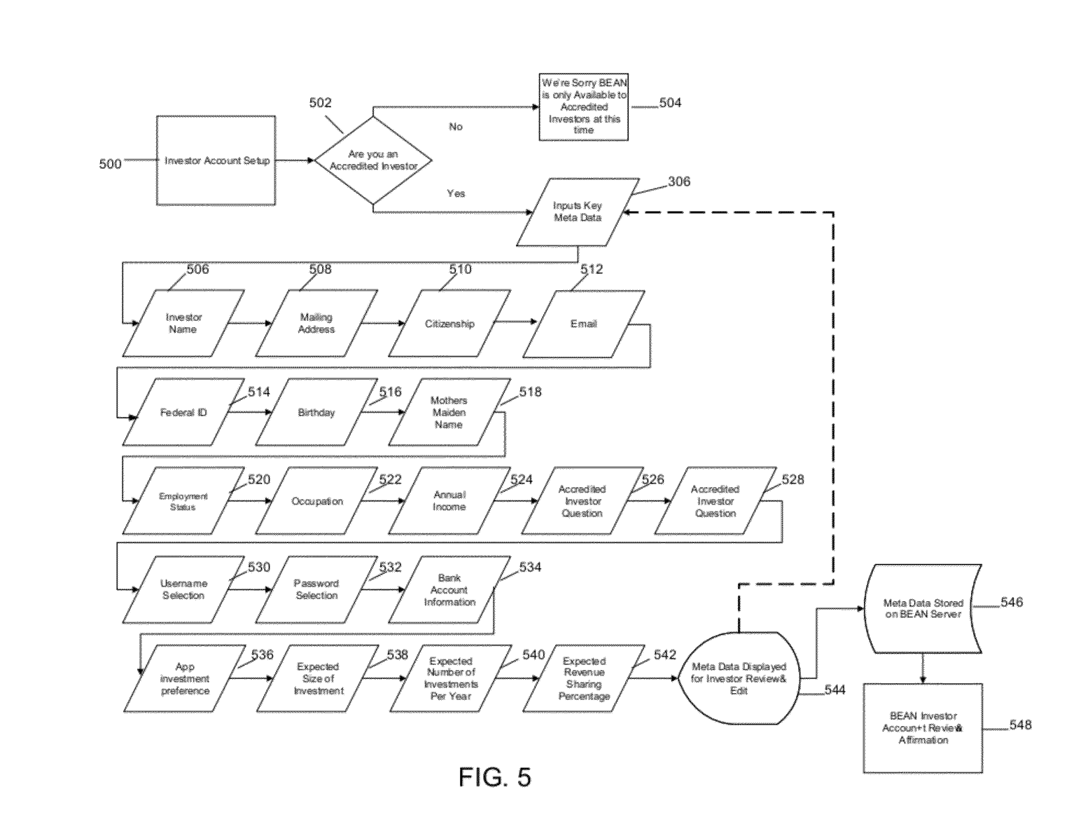

In an embodiment, a system of the present disclosure for raising financial capital by securitizing the revenue stream of a product includes an investor account set-up process 500. In an embodiment, the investor account set-up process is an automated process. FIG. 5 shows an embodiment of the investor account set-up processes that provides a standardized format for capturing the information necessary to determine if the investor meets the requirements for opening an account and to ensure the information necessary for security, accuracy and compliance with applicable laws and regulations.

It is first determined if the investor meets minimum criteria 502—in an embodiment, the investor must be an accredited investor. If the investor does not meet minimum criteria 504, the developer is asked to come back when they meet such criteria. If the investor meets minimum criteria, the investor is allowed to create an account 306. Various types of data and metadata relating to the investor are then collected (e.g. via interactive questions/prompts) including:
Name of investor 506.
Investor mailing address 508.
Investor's country of citizenship 510.
Investors email address 512.
Federal identification number 514 to be used for tax purposes (e.g. EIN, SSN).
Birthday of investor to 516—used in security protocols.
Mother's maiden name 518—used for security protocols.
Investor's employment status 520.
Investor occupation 522 (occupation list scroll can be provided).
Investor annual income estimate 524 (number scroll can be provided).
Accredited investor question 526.
Accredited investor question #2 528.
Investor username selection 530.
Investor password selection 532.
Developers bank account 534 or PayPal account through which the developer will transact business.
The preference of App genre 536 the investor would like to review for potential investments.
Expected size of investment 538 the investor is willing to make.
Expected numbers of Apps the investor expects to invest in per year 540.
Expected amount of revenue the investor is willing to share with developers 542.

Data collected during the process 506-542 are then displayed 544 to the developer for review and correction if necessary. The system then accepts the investor data into the system's storage configuration 546. The system then reviews the investor information, and sends a message to the investor that their account is now available or further information is needed to open an account 548.

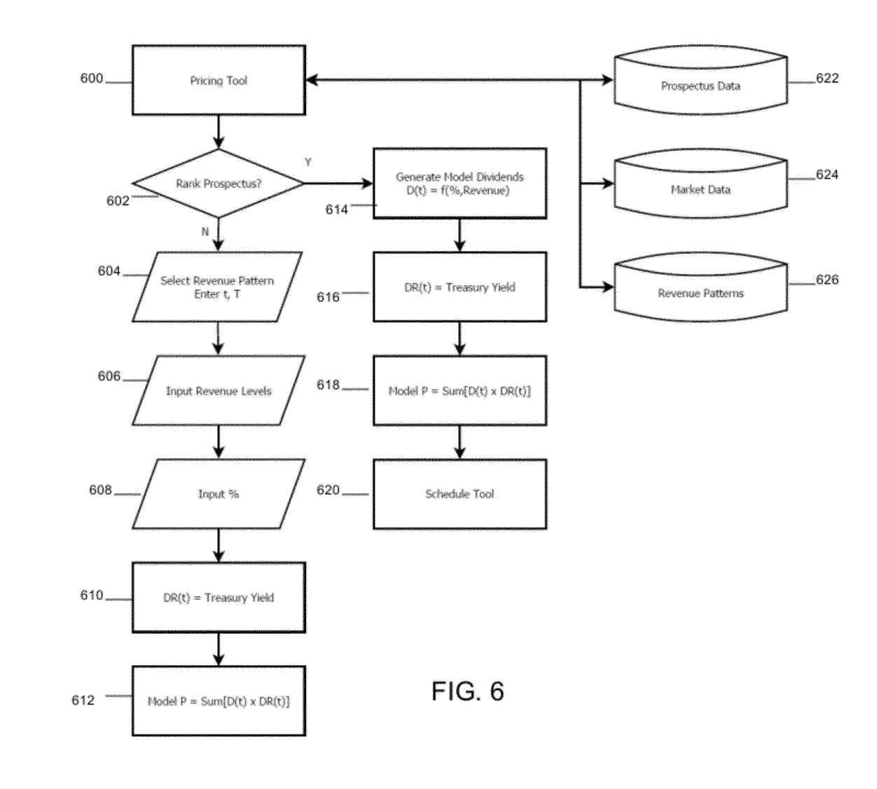

In an embodiment, a system of the present disclosure for raising financial capital includes one or more tools for investors, developers, and entrepreneurs to simplify transactions and maximize transparency while using the system for raising financial capital by securitizing the revenue stream of a product. In an embodiment, the tools are used for pricing, scheduling, and matching. In an embodiment, the tools include a pricing tool. The pricing tool provides a standardized model for calculating expected price given user inputs. FIG. 6 shows that the tool 600 applies a discounted cash flow model with user defined inputs for expected revenues and the percentage of revenue ownerships. In an embodiment, the discount rate is defined by the treasury yield curve.

In an embodiment, the processing of the pricing tool as shown in FIG. 6 is as follows. A pricing tool 600 algorithm schema brings in data from databases storing prospectus data 622 (e.g. from 436 of FIG. 4), market data for other Apps 624 and revenue patterns from other Apps 626. It is then determined if the prospectus information needs to be ranked 602. If the prospectus information does not need to be ranked, a revenue pattern comprising a level of App revenue and a timing of App revenue is selected 604. App revenue levels and type are then input into the pricing tool 606. The percent of revenue to be shared by the developer 608 is input into the pricing tool. The relevant treasury rate 610 is input into the pricing tool. A discounted cash flow model then developed 612 based on the percent of revenue to be offered by developer.

If the prospectus information needs to be ranked (e.g. in response to a request from the scheduling tool, a dividend function 614 is developed based on percent of revenue to be offered by developer. The relevant treasury rate 616 is input into the pricing tool. A discounted cash flow 618 is then developed based on the percent of revenue to be offered by developer and the data sent to the auction schedule tool 620 (described in greater detail immediately below).

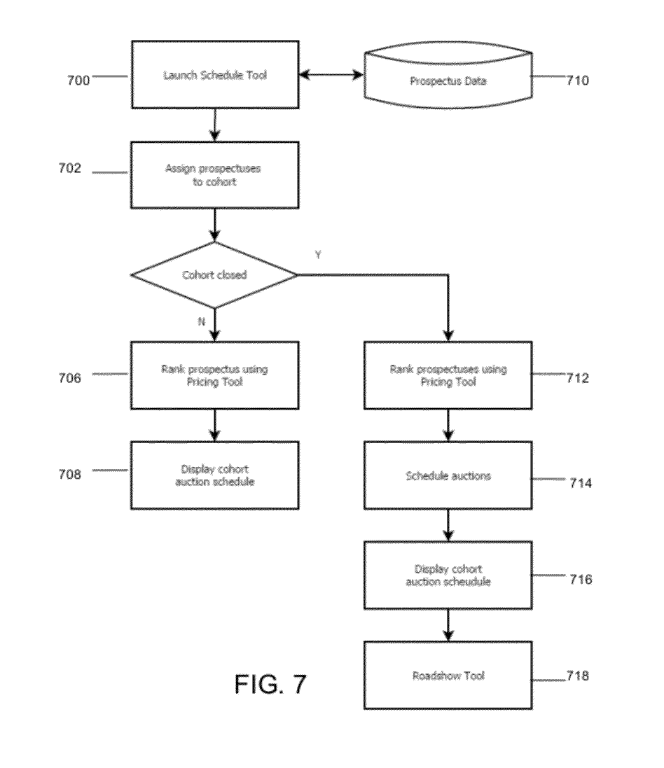

In an embodiment, the tools include a scheduling tool for scheduling auctions for investors to acquire newly issued AppShares in the primary market. In an embodiment, the scheduling tool is for scheduling auctions based on the timing of the prospectus submission and the current revenues of the App. FIG. 7 shows that all submissions within a defined time period are gathered into a cohort. The AppShares within each cohort are then sorted as determined by the pricing tool, or other methodology, using a consistent set of rules.

In an embodiment, the processing of the schedule tool as shown in FIG. 7 is as follows. The schedule tool is launched 700 and brings in data in from the prospectus database 710 (e.g. 436 of FIG. 4). Prospectuses are assigned to a cohort 702 within a defined timeframe. It is then determined if the auction can be included in the current cohort 702. If the auction can be included in the current cohort (i.e. the cohort is not closed) the prospectuses of the offered AppShares are ranked 706 according to the pricing tool calculation. The ranked cohort auction schedule can then be displayed 708 to investors and developers.

If the auction cannot be included in the current cohort (i.e. the cohort is closed), a new cohort is opened and offered AppShares are ranked 712 according to the pricing tool calculation. Auctions are then scheduled according to rank 714 and the ranked cohort auction schedule can be displayed 716 to investors and developers. Once the auction is scheduled developers and investors can access roadshow tool 718 (described below).

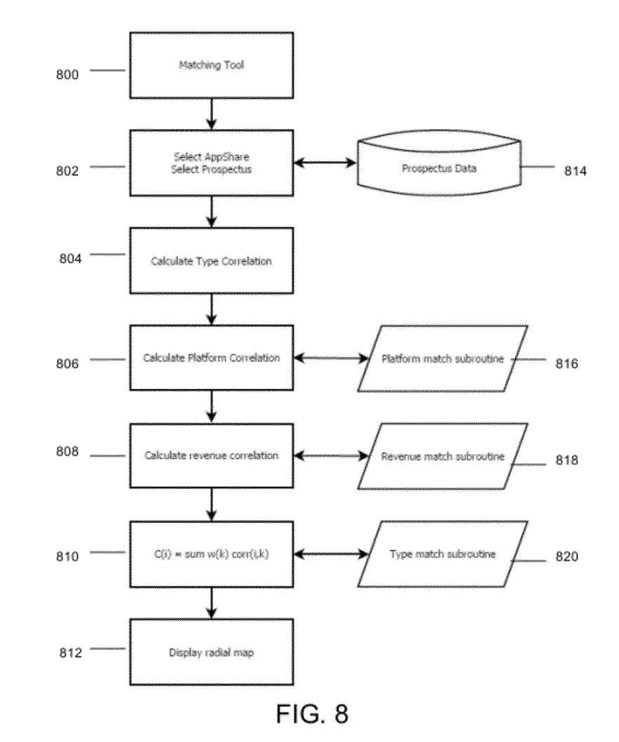

In an embodiment, the tools include a matching tool. In an embodiment, the matching tool can be used for searching for Apps given a set of user defined characteristics. In an embodiment, the matching tool can be used to identify comparable Apps given a user defined App. FIG. 8 shows that the tool calculates the similarity of Apps across three broad dimensions, then summarizes these similarities using a scoring model to rank order the Apps. The results are presented either across multiple dimensions (i.e. radial map) or the summary rank (i.e. list).

In an embodiment, the processing of the matching tool as shown in FIG. 8 is as follows. An investor or developer launches the matching tool 800. The inquirer (e.g. an investor or developer) selects a trading share or prospectus 802 from a pending offering from the prospectus database 814 (e.g. 436 of FIG. 4). A correlation calculation 804 is then set up. Such correlation calculation can include, without limitation, a platform correlation calculation 806, a revenue correlation calculation 808 and a correlation of platform and revenue 810. A multidimensional radial map can then be displayed 812. In the above exemplary implementation 816 represents a subroutine to screen all platforms, 818 represents a subroutine to screen all revenue and 820 represents a subroutine for matching the platforms and revenue.

In an embodiment, a system of the present disclosure for raising financial capital by securitizing the revenue stream of a product allows community participants to access the system through the internet at a home page of the system. In an embodiment, the community participants include investors, developers, companies, and entrepreneurs. For mobile users, Apps will be developed that will be available for different mobile platforms and operating systems. In an embodiment, accounts will be setup on the internet home page but once the accounts are established the community participants will be able to participate in BEAN Auctions through a computer program or App called the Auction BEAN. For those interested in trading listed AppShares a computer program or App called the Trading BEAN can be used to trade on the secondary market.

In an embodiment, a system of the present disclosure for raising financial capital by securitizing the revenue stream of a product includes appropriate redundancy in servers, security algorithms and access points that will be the hardware used to maintain the system. In an embodiment, a downloadable program can be downloaded onto a community participant's personal computing device (i.e. laptop, PC, tablet, etc.) where the community participants can also access the system.

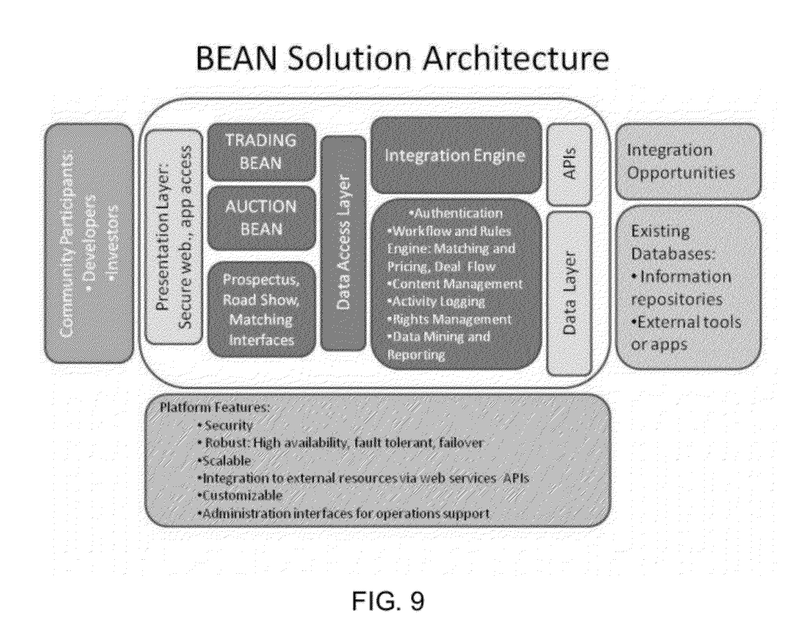

FIG. 9 shows an embodiment of an architecture for delivering a system of the present disclosure for raising financial capital by securitizing the revenue stream of a product. FIG. 9 depicts a service oriented architecture that can deliver the multiple user experiences and workflows required for the fundamental functionality/workflow steps previously described. In an embodiment, the system architecture is designed to be secure and robust, with network implementation designed to provide high availability, fault tolerance, and failover capabilities to ensure transaction integrity. In an embodiment, the architecture is modular and scalable, and will support integration to external resources via web services APIs to external resources where required (e.g., App stores, etc.).

In an embodiment, the system architecture is a framework that supports:
customization of user experience and workflow;
administration interfaces and monitoring to support market operations; and
management for market trustworthiness.

In an embodiment, a customized web or App based user experience is delivered via a presentation layer to developers and investors to support the functional activities of these users in the system, including development of an investment prospectus, interaction with the an investment electronic roadshow, pricing, scheduling, searching and matching tools, auctions, and trades.

In an embodiment, the presentation layer delivers administration interfaces to support market operations. In an embodiment, a rules engine provides workflow and intelligence support for the processes and algorithms described herein.

In an embodiment, access control and rights management is also delivered, and a database architecture supports detailed data mining of marketing dynamics and reporting requirements.

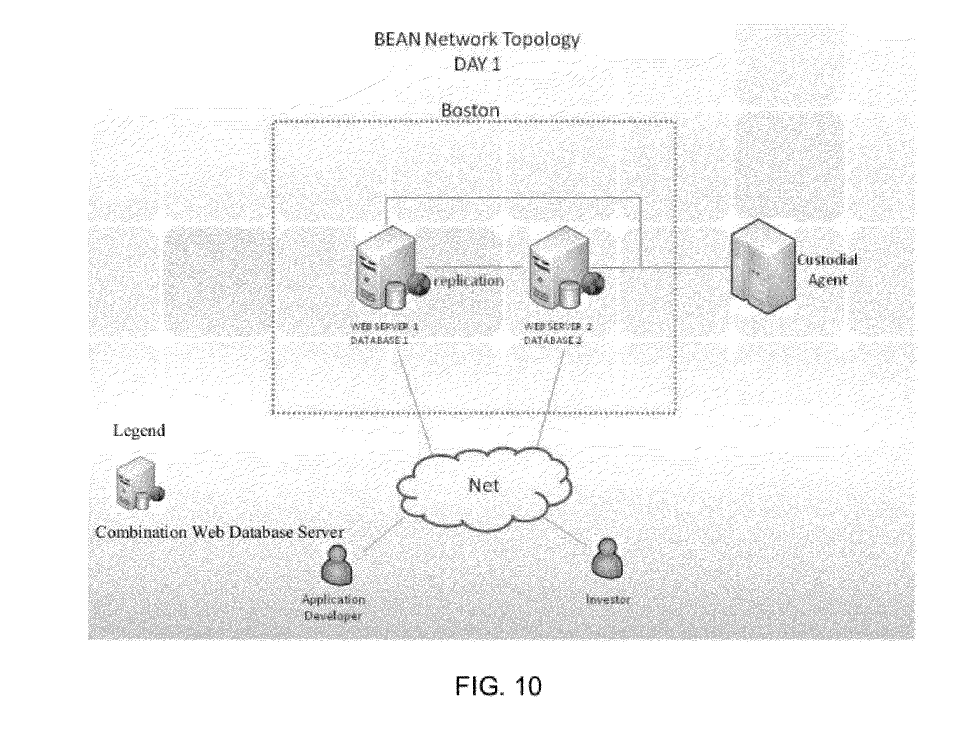

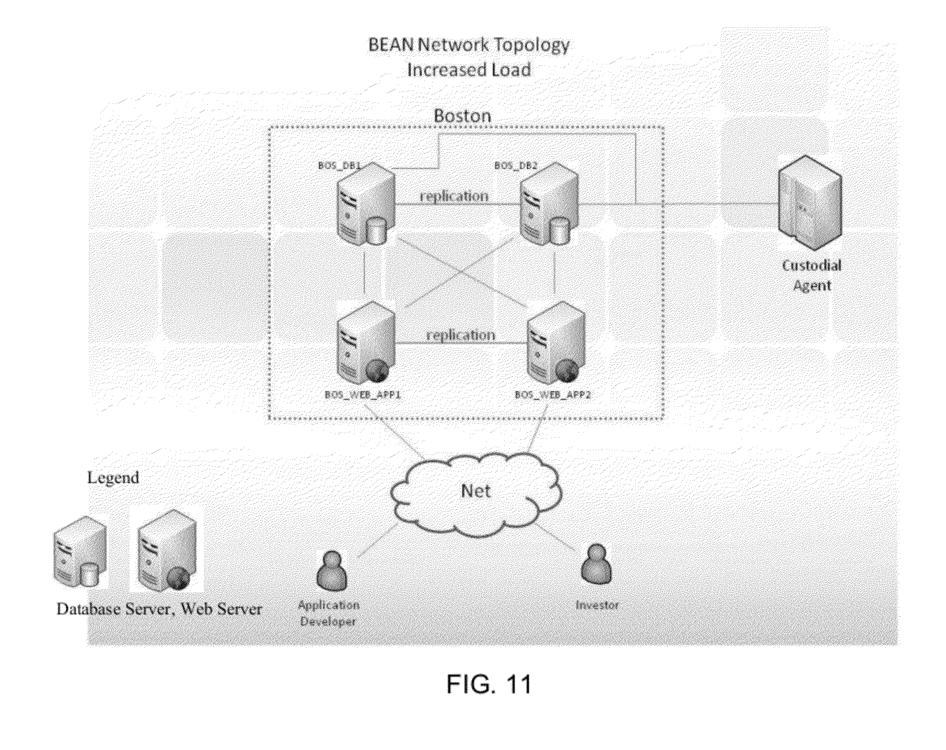

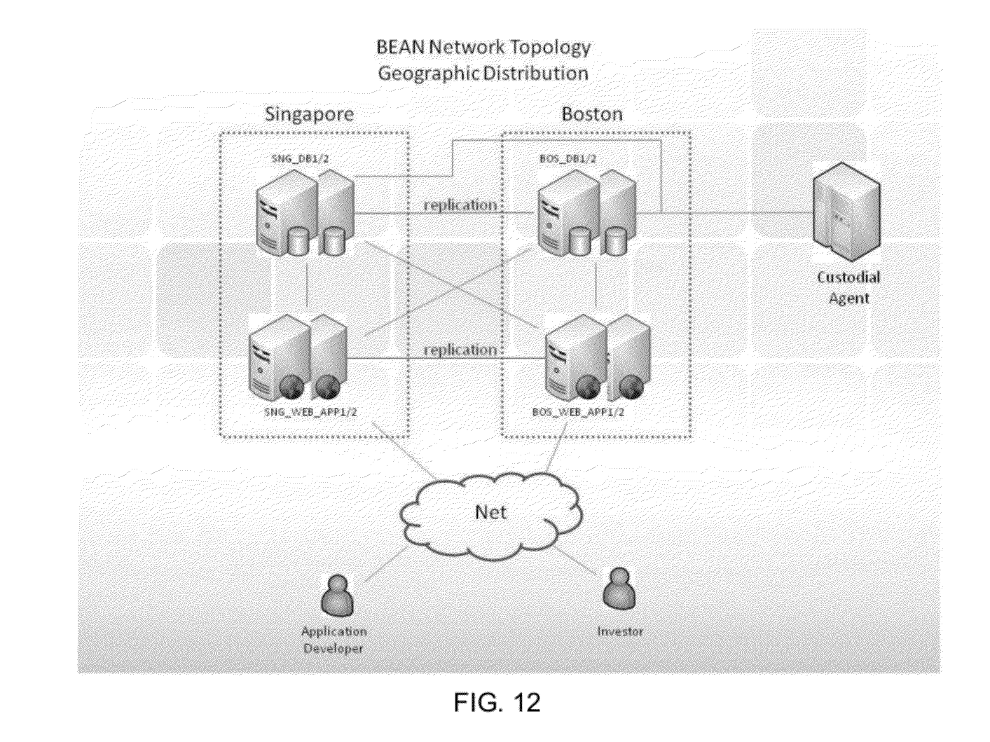

In an embodiment, a system of the present disclosure for raising financial capital by securitizing a revenue stream of a product includes software designed in a modular fashion as to provide redundancy and availability is redundant and scalable. As shown in FIG. 10, the Day 1 topology will provide the minimum architecture necessary to ensure redundancy. The logical components of database and application server will share a physical node. This provides an economic entry while maintaining reliability. Peer redundancy modules in the applications servers will be responsible for replicating the state of the application servers. Best practice database synchronization techniques are used to guarantee data redundancy. As shown in FIG. 11, as network traffic and server demand grow, the logical components may be broken out of the physical nodes into separate servers or virtual instances. This will provide more processing power, and increase network capacity for each server. In time, as more demand grows internationally, the system will accommodate scalability across the globe as illustrated in FIG. 12. Each geographic area will be able to maintain high availability by scaling for localized demand.

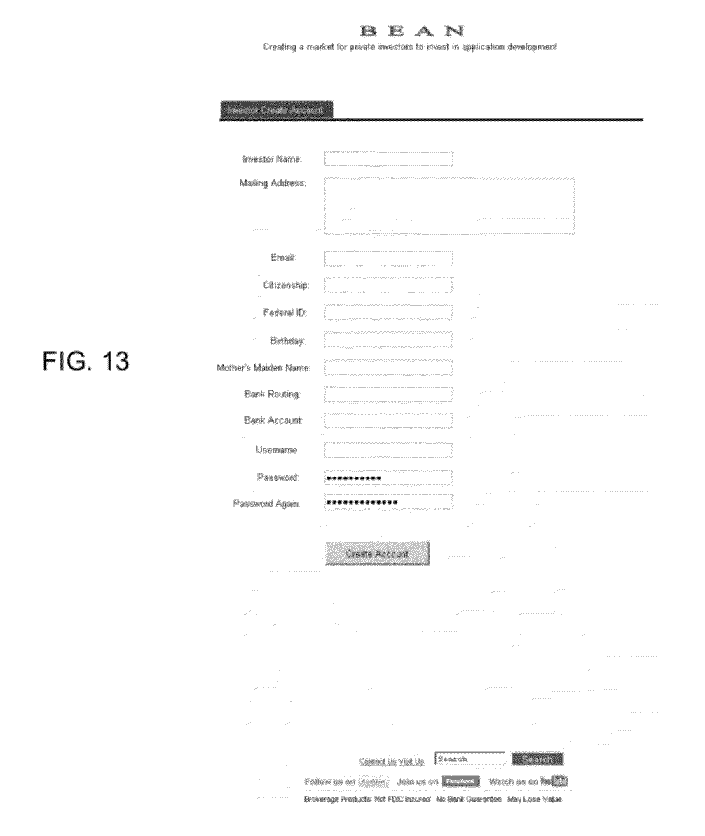

In an embodiment, users or community participants of the system of the present disclosure will be required to create an account. FIG. 13 is a picture showing a screenshot of an embodiment of an investor account creation page. The page provides a standardized easy-to-use format for capturing the information required to open an account.

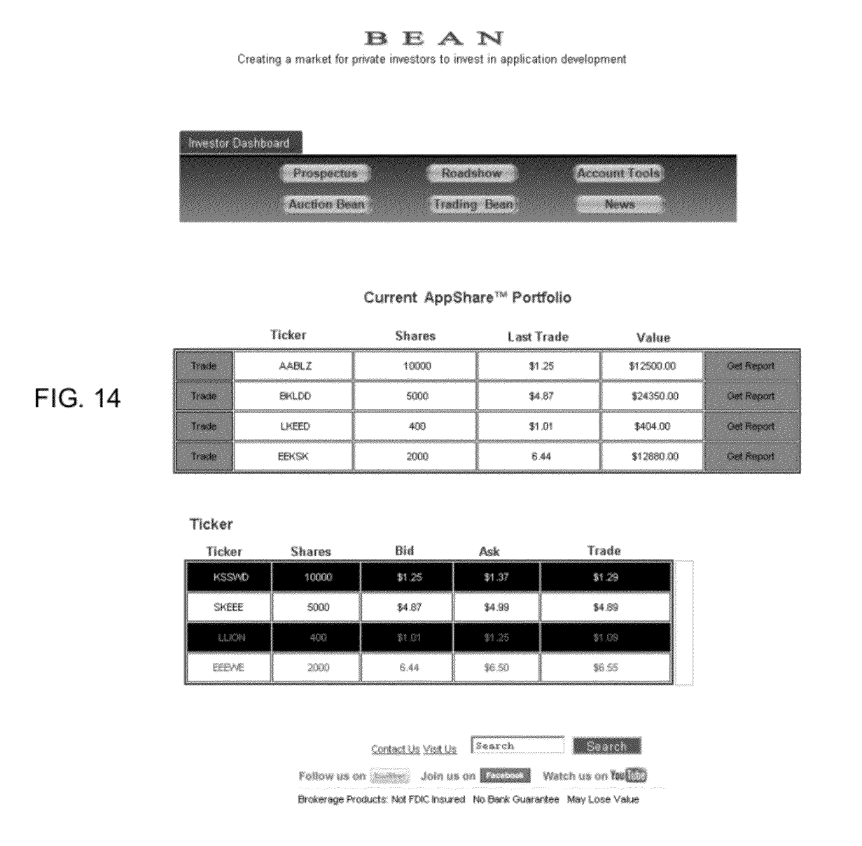

In an embodiment, the dashboard is an investor dashboard. As shown in FIG. 14, after an investor creates an account they will be able to access a dashboard the links them to the functions for participation in the system. The dashboard provides the investor a single location to monitor and manage all of their activities within BEAN: including the current auction schedule and auction results; access to submitted prospectuses, roadshow materials, tools and necessary documentation; current portfolio holdings; as well as, access to the Trading BEAN.

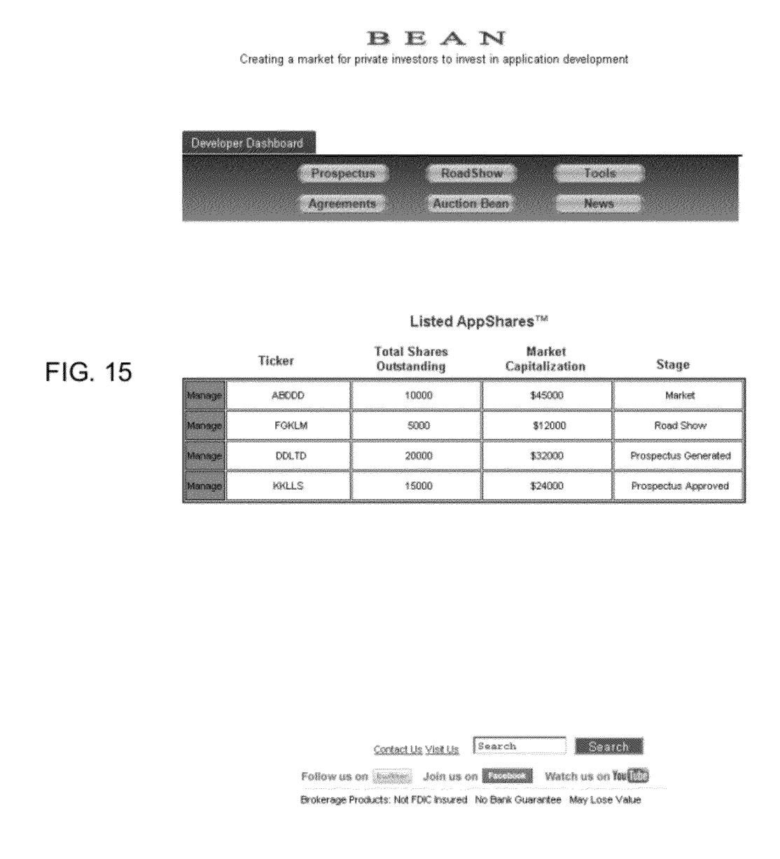

In an embodiment, a system of the present disclosure for raising financial capital by securitizing the revenue stream of a product includes a dashboard. In an embodiment, the dashboard is a developer dashboard. As shown in FIG. 15, after a developer creates an account they will be able to access a dashboard that links the developer to the functions for participation in the system. The dashboard provides the developer a single location to monitor and manage all of their activities within BEAN: including the development and submission of prospectuses and roadshow materials; access to tools and necessary documentation; as well as, market information on previously issued AppShares.

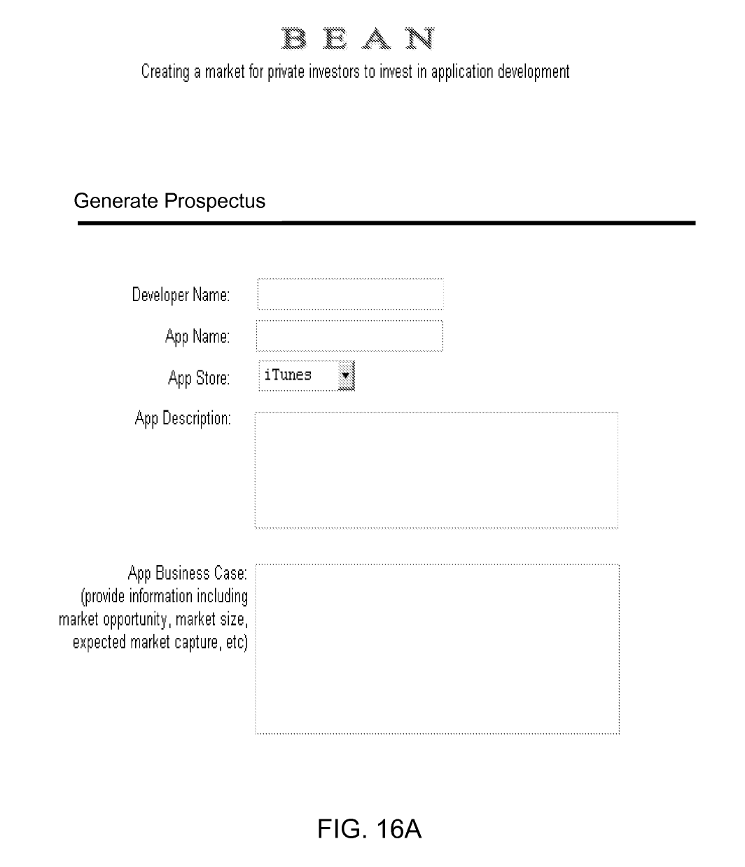

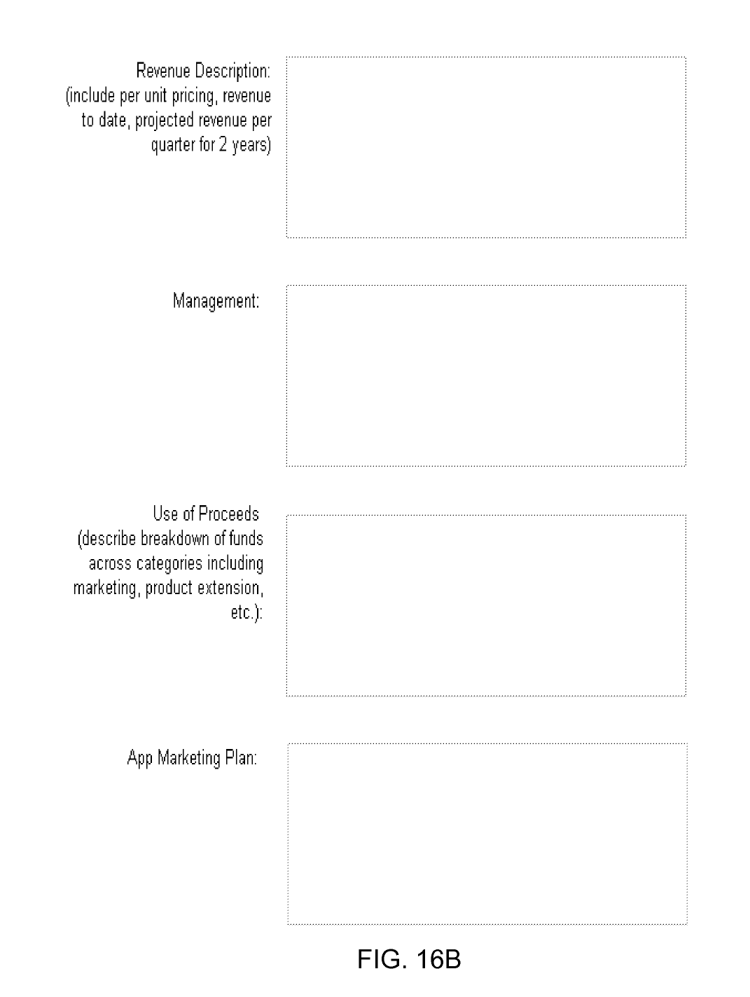

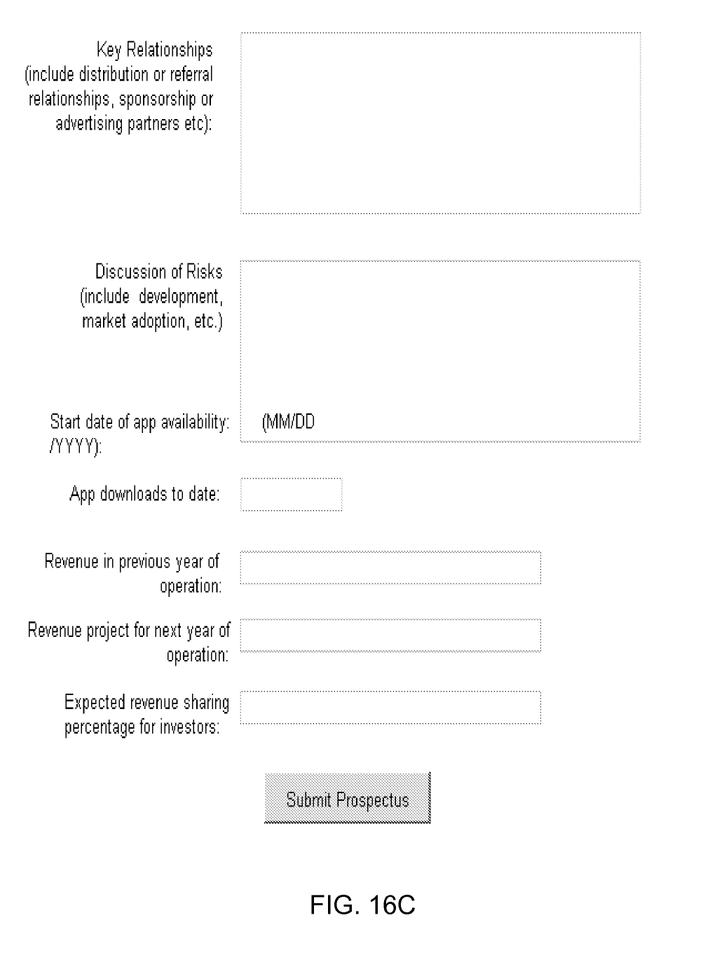

In an embodiment, a system of the present disclosure for raising financial capital by securitizing the revenue stream of a product includes a prospectus. For a developer to list an App they will fill out a set of required information that will generate a prospectus for investors to review. FIG. 16 shows a screenshot of an embodiment of an online form that allows a developer to submit the prospectus. In an embodiment, the prospectus describes the App, identifies the developer, indicates the percentage of revenues being offered, indicates which platforms the App is sold on, and provides a history of revenues to date. In an embodiment, the prospectus includes warrants and disclosures.

In an embodiment, a system of the present disclosure for raising financial capital by securitizing the revenue stream of a product includes prospectus screening. Submitted prospectuses are screened for completeness and information is entered into a database of the system of the present disclosure. Some information from the prospectus, e.g., App type, platforms on which the App is offered, total revenues, is verified. In an embodiment, verification is a semi-automated process that verifies the following information upon submission: App type, platforms, App selling price, current revenue, and the developer has acknowledged the warrants and representations.

In an embodiment, a system of the present disclosure for raising financial capital by securitizing the revenue stream of a product assigns a ticker symbol for an App. In an embodiment, each App is assigned a unique five letter ticker symbol to facilitate trading. The developer selects the ticker when submitting the prospectus. The prospectus submission process screens for symbols already in use and proscribed symbols. Five letters and a blank provide for over 9.6 million unique identifiers. This can be expanded in the future by adding numbers or expanding the number of letters.

In an embodiment, a system of the present disclosure for raising financial capital by securitizing the revenue stream of a product schedules auctions. In an embodiment, auctions are scheduled based on a predetermined submission schedule. Each App is assigned to a cohort and then each cohort is sorted based on expected auction price or some other methodology. In an embodiment, auctions are scheduled using an App Scheduling Tool with the current and next cohort auction schedule available for viewing online. After the auctions are scheduled, there is a 2 week period for the community to review the auction schedule and evaluate the Apps offered.

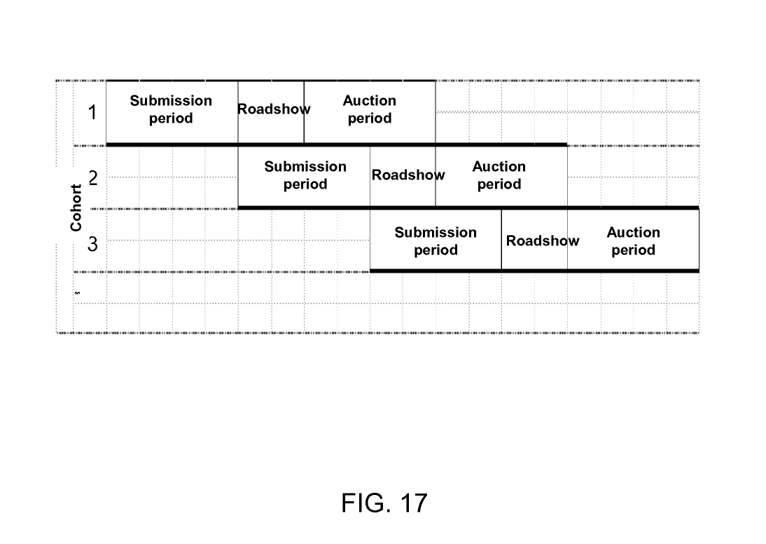

FIG. 17 shows a timeline of the submission period, roadshow, and auction period for Apps as assigned to a cohort. The schedule is designed so there are no gaps: developers can always submit a prospectus; and investors have access to the roadshow and primary market. In an embodiment, a system of the present disclosure for raising financial capital by securitizing the revenue stream of a product includes an electronic roadshow. For a developer to list an App they will fill out a set of required information that will generate an electronic roadshow for investors to review prior to the auction.

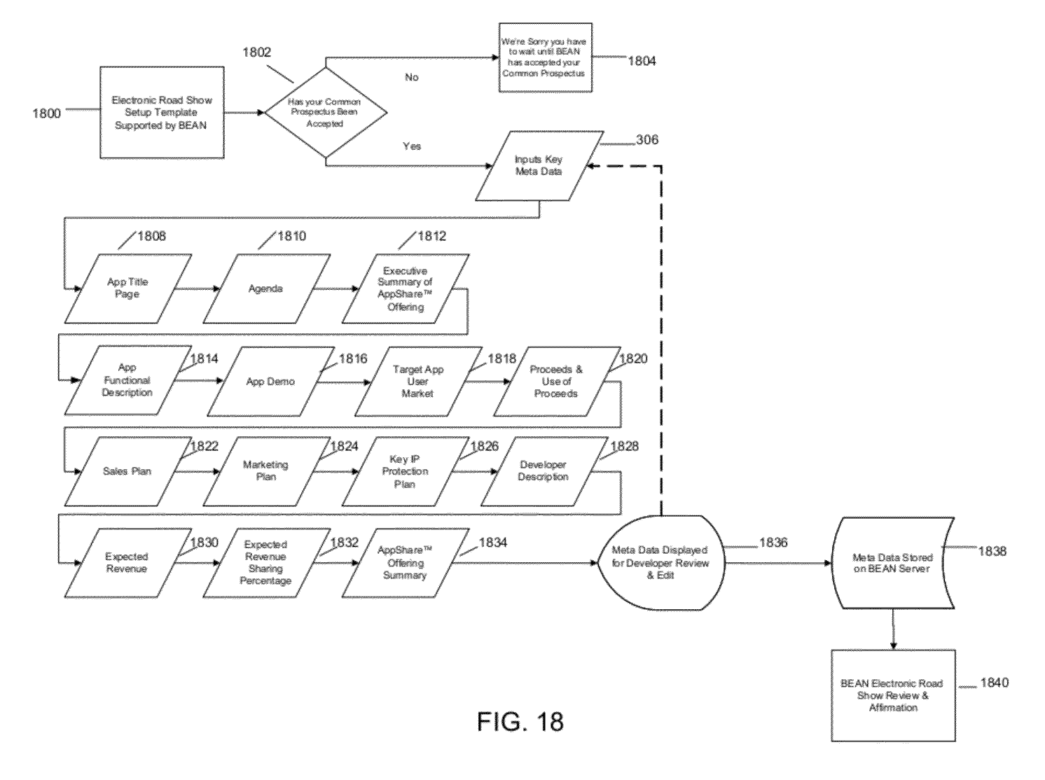

FIG. 18 illustrates the process and set of required information for generation of an electronic roadshow 1800 for investors to review in accordance with an embodiment of the system of the present disclosure. A developer who wishes to submit a prospectus to a road is asked if their common prospectus has been accepted 1802. If the developer's common prospectus not accepted yet, the developer instructed to wait 1804. If the developer's common prospectus has been accepted, the developer can initiate roadshow function to develop a presentation of the offering, (i.e. function of the App, business model, etc.) to inform potential investors. Information provided for a roadshow can include:
Title page of the offering 1808 describing the App and developer.
Agenda of the presentation 1810.
Executive summary of the AppShare offering 1812.
Written functional description of the App 1814.
Demonstration of the App function 1816, screen shots, or restricted live version.
Summary description of the target App user market 1818.
Summary description of how the proceeds will be used 1820.
Summary description of the sales plan for the App 1822.
Summary description of the marketing plan for the App 1824.
Summary description of intellectual property protection plan 1826.
Summary description of the developer and his or her history as a developer 1828.
Summary description of the expected revenue the App will generate 1830.
Summary description of the amount of revenue to be shared with investors 1832.
Summary of the AppShare offering describing the salient financial, business, and offering details 1834.

The system can then display data from preceding questions (1808-1834) for the developer to review and correct if necessary 1836. The system then accepts roadshow data 1838 into its storage configuration and sends message to developer that their roadshow is now available for investor review or further information is needed 1840.

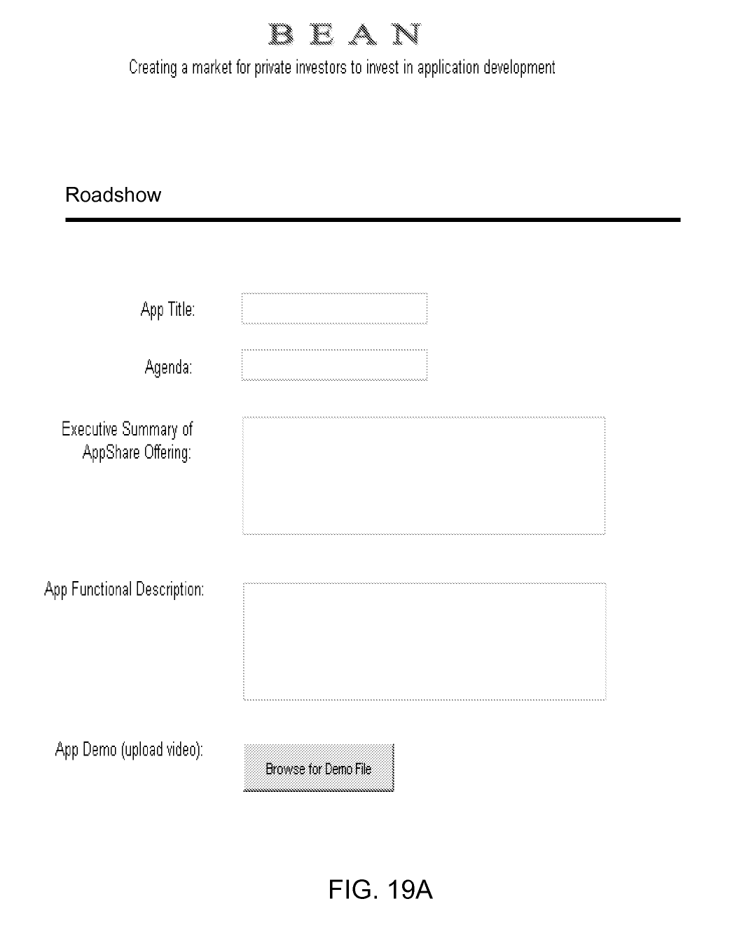

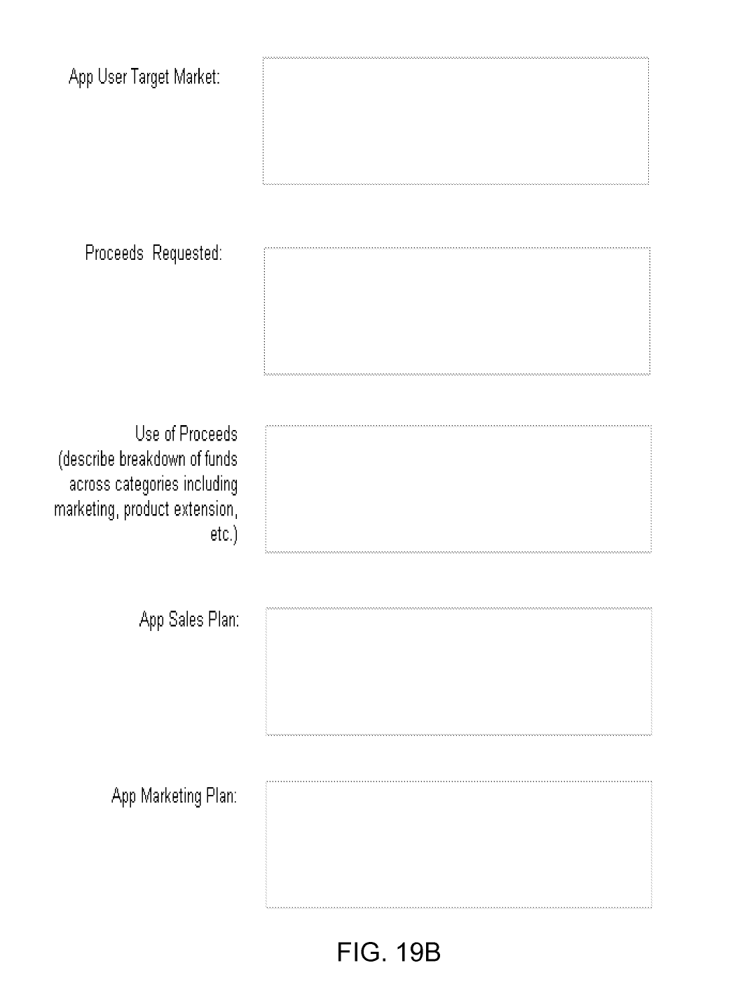

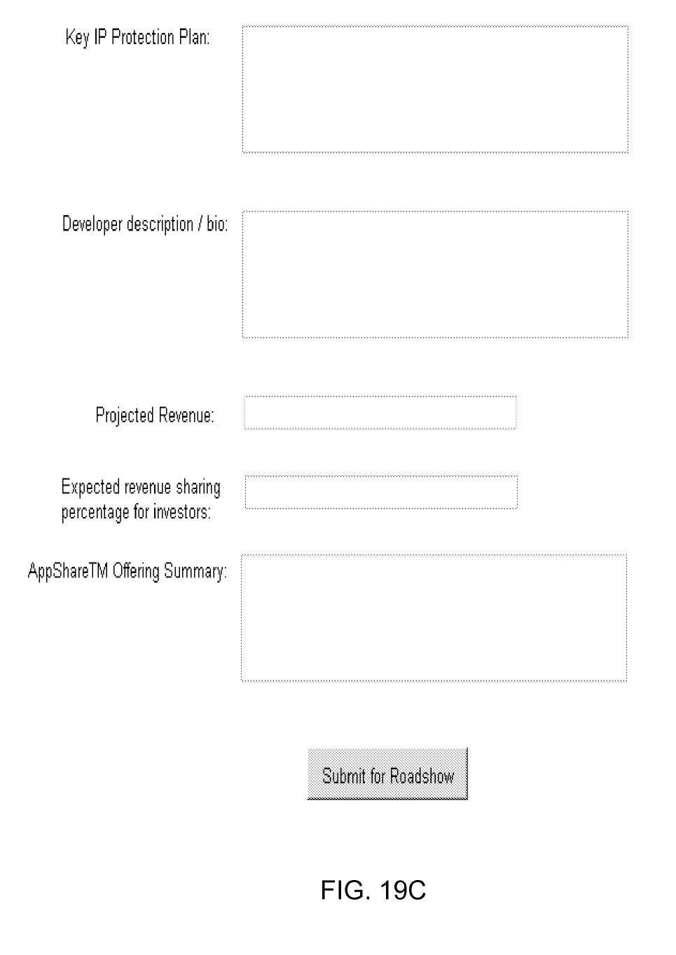

FIG. 19 shows a screenshot of an embodiment of an online form used by the developer for submitting the information necessary to fully describe the App to potential investors for the purposes of marketing the App in advance of the primary market auction. This information is intended to allow investors to make informed decisions and maximize proceeds to developer. In an embodiment, the electronic roadshow allows the community participants of the system to review the auction schedule and evaluate the Apps offered.

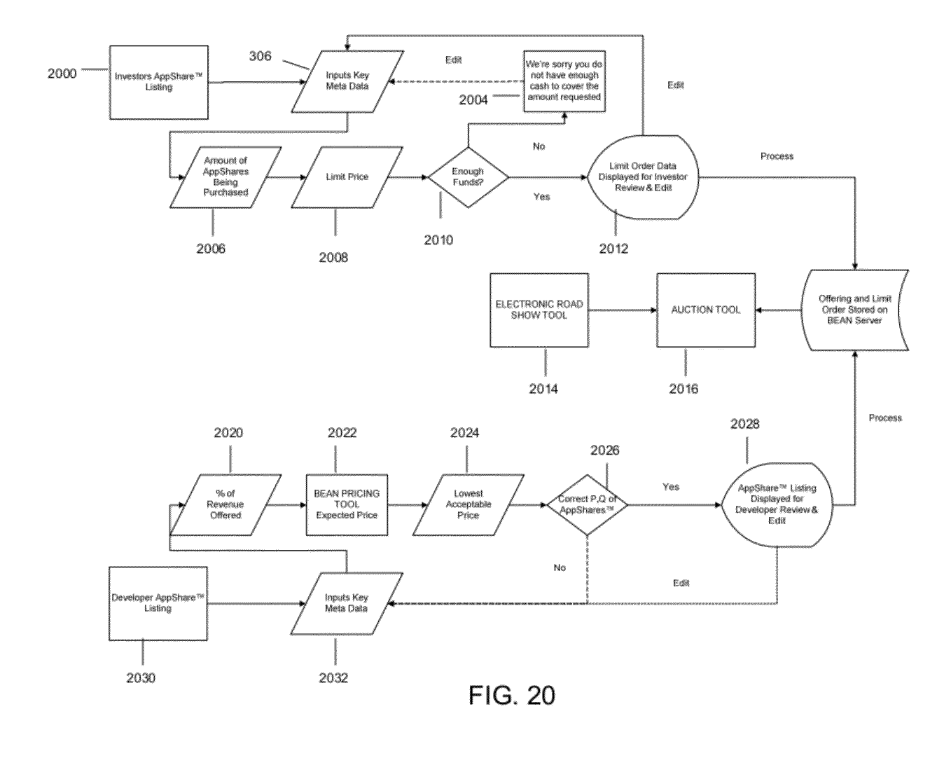

In an embodiment, the primary market includes an auction for issuing new AppShares. FIG. 20 illustrates the process 2000 by which developers submit Apps and investors submit bids to the Auction BEAN.

On the investor side of the process, the investor first selects an AppShare listing in an AppShare auction 2000 the investor has an interest in. The investor then inputs key metadata 306 to take part in the applicable AppShare auction, which can include the number of AppShares to be purchased 2006 and a limit price to purchase AppShares 2008. The electronic roadshow tool 2014 can be used by investors to review an offering prior to placing an order.

The amount of AppShares is multiplied by the limit price and the total amount of the order is checked against available funds 2010. If the investor has submitted an order that cannot be accepted because of lack of funds or other error 2010, the investor is not allowed to participate in the auction and is given an opportunity to modify his or her order 2004. If the investor has submitted an order that cannot be accepted, the system displays data from the preceding questions (2002-2010) for review content and correction if necessary 2012. The electronic roadshow tool 2014 allows investors to review an offering prior to placing an order.

On the developer side of the process, when a developer decides to auction a percentage of App revenue to investors using AppShares, the developer selects one or more of his or her listings 2030 for auction. The developer then inputs key metadata to take part in an AppShare auction 2032, which can include the amount/percent of revenue offered 2020. The developer can then, using the pricing tool, calculate the expected share price and inputs the lowest acceptable price 2024. The system then calculates the correct price and number of AppShares to be offered 2026 based on developer input. The system then displays data from the preceding operations (2020-2026) for review and correction if necessary 2028.

The system then accepts investor and developer data into its storage configuration. The auction tool function 2016 is then used to run an auction with information submitted by the developer and investor. In an embodiment, the auction is a multiple unit, homogeneous, closed second price auction where the developer/entrepreneur has no discretion to set the offering price but determines the percentage of the revenue stream of the App that is securitized by the AppShares.

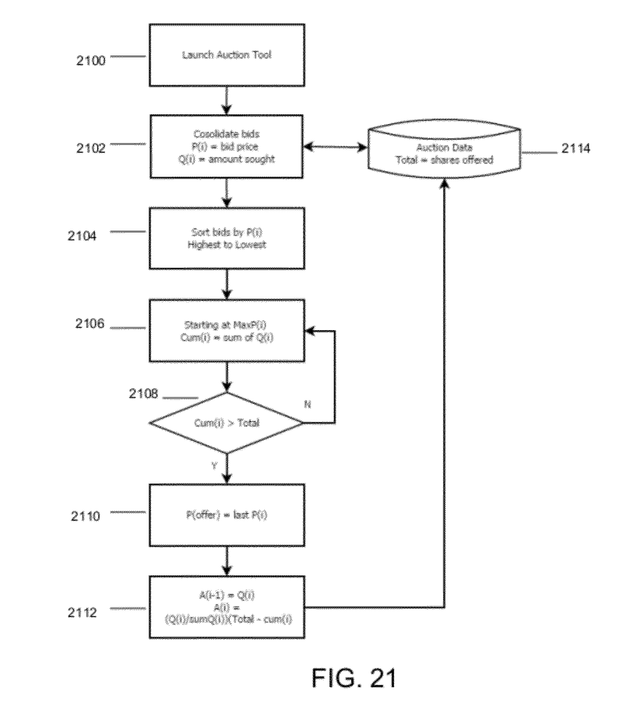

In an embodiment, the auction process implemented by the auction tool, as shown in FIG. 21, includes the following rules:

1. Each investor submits a single or multiple bid(s) that indicates the number of AppShares desired and the maximum price the investor is willing to pay for these AppShares;
2. All bids and quantity of AppShares are consolidated 2102 and saved within the system's internal storage configurations 2114;
3. All bids must be submitted within the 2 week electronic roadshow and remain sealed until the auction;
4. At the auction, all bids are opened and sorted in descending order by price 2104 with the running total of quantity of AppShares desired;
4. The clearing price is set at the lowest winning bid, i.e., the price at which the running total equals or exceeds the AppShares offered.
5. Starting with the first price set AppShares are allocated according to auction rules 2106.
6. All bids above the clearing price receive full allocations. All bids at the clearing price receive pro rata allocations of the remaining App Shares.
7. Allocation continues until the auction allocates all available AppShares 2108.
8. The description of the offering price 2110 and the total amount of AppShares issued during the auction 2112 are then saved within the system's internal storage configurations 2114.

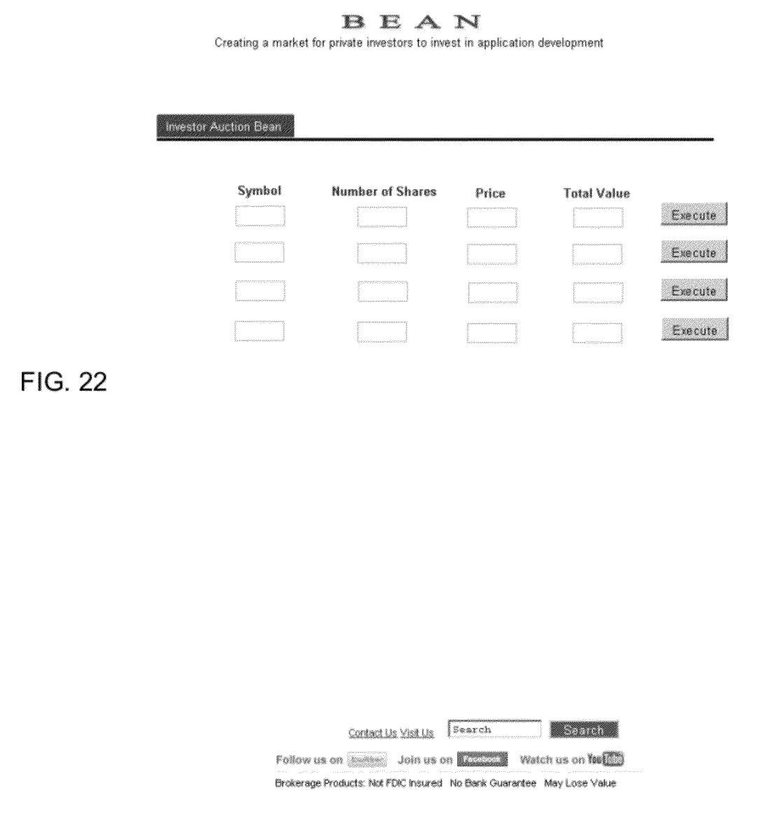

In an embodiment, the auction includes a web page known as Investor Auction BEAN. As shown in FIG. 22, the Investor Auction BEAN screen provides the investor a standardized format for submitting auction bids. The investor inputs the ticker symbol, number of AppShares desired, and bid price. The Total Value of the bid is calculated for reference. If satisfied, the investor clicks the “Execute” button to submit the bid.

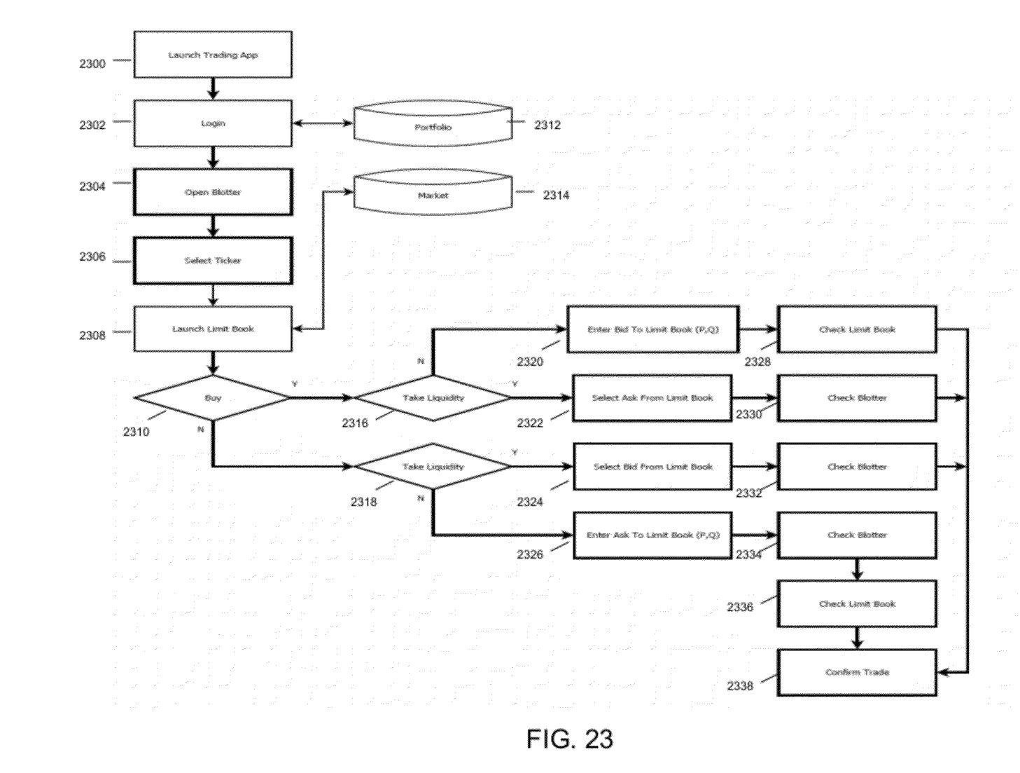

In an embodiment, the secondary market is used to trade previously issued AppShares. In an embodiment, the secondary market is an application for trading known as the Trading BEAN software or App. All trading is done through the Trading BEAN software or App. The Trading BEAN software or App presents the current limit order book for a particular AppShare and is available to all investors 24 hours a day. In an embodiment, the Trading BEAN software or App provides disintermediation by removing the broker/dealers layer, reducing trading costs to participants and removing a potential conflict of interest. As shown in FIG. 23, all trades in the secondary market must be limit orders as follows:
Investors looking to buy either select a posted limit order (ask) or post a limit order (bid);
Investors looking to sell either select a posted limit order (bid) or post a limit order (ask);
All orders are good-till-cancel orders, i.e., valid until accepted by another investor or canceled by the posting investor;
Submitted orders are screened to:
   Check Limit—ensure the entered trade is valid, i.e., the investor has the necessary capital or AppShares;
   Check Blotter—confirm the investor wants to execute an entered trade that is far from current market prices;
   Confirm the investor wants to execute an entered trade.
Identity of participant is not revealed;
No minimum trade size;
No short sales allowed;
No leverage or margin allowed.

In an embodiment, the functions performed by an online trading application 2300 are further illustrated in FIG. 23. Following an AppShare auction, investors can trade listed AppShares. An investor first launches the online trading application 2300 and logs into 2302 his or her portfolio account 2312 (which includes data relating to owned AppShares). The investor can then view positions they have outstanding in the blotter 2304. To place an order, the investor selects an AppShare ticker symbol 2306. Once an AppShare ticker has been selected a limit order book activates 2308 allowing the investor to place a limit order relating to AppShares currently on the market 2314. The investor then decides to purchase or sell liquidity 2310.

If the investor decides to purchase 2316 a listed AppShare, the investor enters a bid 2320 on a quantity of the AppShare or selects an ask price from the limit book 2322. If the Investor decides to sell 2318 a listed AppShare, the investor selects a bid price from the limit book 2324 or enters an ask price on a quantity of a listed App Share 2326. Where an investor enters a bid to the limit book 2320 or an ask to the limit book 2326, the bid or asked is checked against the limit book, 2328 or 2336 respectively. When an investor enters an ask from the limit book 2326, a bid from the limit book 2324 or an ask to the limit book 2326, the investors account is checked, 2330, 2332 and 2334 respectively. If no errors are found and the market accepts the order the investors order is executed 2338.

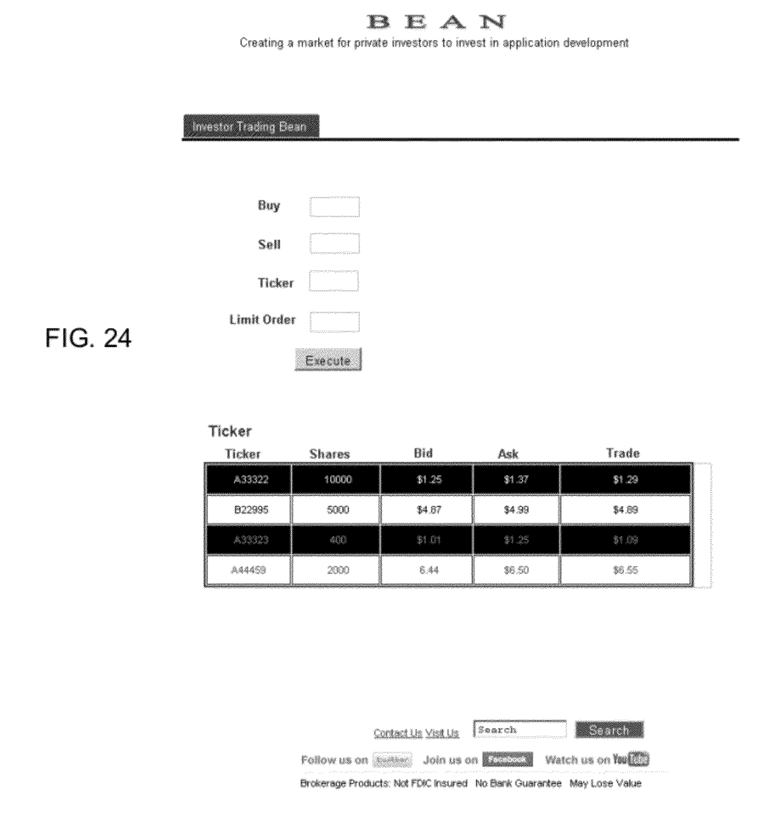

FIG. 24 illustrates a screenshot of an embodiment of the Trading BEAN software or App for investors to trade previously issued shared in the secondary market.

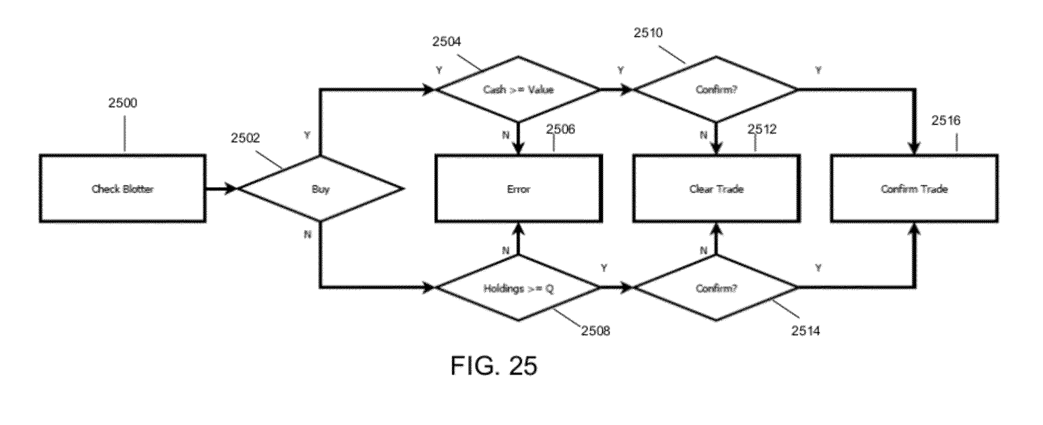

FIG. 25 illustrates one embodiment of a check blotter function that checks the investors account to ensure the accurate amount of AppShares and funds are available to transact the desired trade. In various embodiments, the check blotter function 2500 corresponds to the check blotter functions 2330, 2332 and 2334 of FIG. 23. When the function 2500 is called, it is first determined if the investor has made a decision to buy or sell liquidity 2502 into the market.

If the investor has decided to buy liquidity, the investor account is checked 2504 to ensure the appropriate amount of funds are available. If there are not enough funds available in the investor's account, an error message 2506 is presented to the investor. If the appropriate amount of AppShares or funds are available 2510, the trade is cleared 2512 and the investor account alerted to confirmation of a successful trade 2516.

If the investor has decided to sell liquidity, the investors account checked 2508 to ensure the appropriate number of AppShares are available. If the appropriate number of AppShares are not available, an error message 2506 is presented to the investor. If the appropriate amount of AppShares are available 2514, the trade is cleared 2512 and the investor account alerted to confirmation of a successful trade 2516.

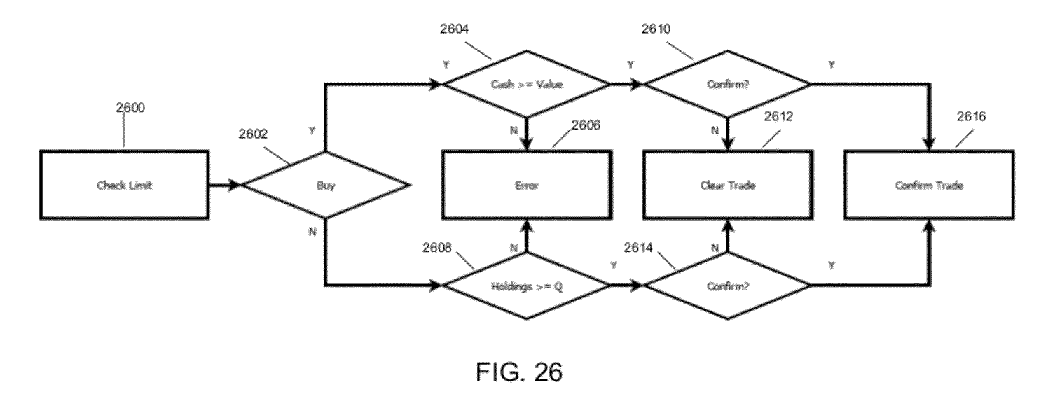

FIG. 26 shows the order entry error checking process for the market limit book, ensuring that the investor has the necessary funds or AppShares to execute the order entered. When the function 2600 is called, it is first determined if the investor has made a decision to buy or sell liquidity 2602 into the market.

If the investor has decided to buy liquidity, the investor account is checked 2604 to ensure the appropriate amount of funds are available. If there are not enough funds available in the investor's account, an error message 2606 is presented to the investor. If the appropriate amount of AppShares or funds are available 2610, the trade is cleared 2612 and the investor account alerted to confirmation of a successful trade 2616.

If the investor has decided to sell liquidity, the investors account checked 2608 to ensure the appropriate number of AppShares are available. If the appropriate number of AppShares are not available, an error message 2606 is presented to the investor. If the appropriate amount of AppShares are available 2614, the trade is cleared 2612 and the investor account alerted to confirmation of a successful trade 2616.

In an embodiment, the limit order book displays total quantity of orders offered at a particular price. In an embodiment, order fill is prioritized by price, quantity and then by time.

To use the Trading BEAN software or App, investors would launch the software or App then enter/select the desired ticker. The top pane of the window displays the current limit order book for the App, i.e., for each price the total quantity of AppShares being offered (sellers ask price) and sought (buyers bid price). The current market price is displayed as a shaded bar. The bottom part of the window can be used to display user defined information about the App, e.g., price/volume chart, revenue history, to name a few.

In an embodiment, if the investor wants to select a posted order:
The investor would select the quantity field of the appropriate column, i.e., if the investor wants to buy (sell) AppShares they would select the ask (bid) quantity at the price level they are willing to pay (accept).
The investor would then indicate how many AppShares they wanted to buy (sell).
The Trading BEAN software or App would verify that the trader's account either has sufficient cash (AppShares) to buy (sell) the indicated quantity. If so, the desired trade is submitted to the market. If not, the trader receives an error message indicating the reason the trade was not accepted.
   In an embodiment, if the investor wants to post an order:
The investor would select the “post limit order” button on the App window;
A pop-up menus would request a trade type (offer to buy or sell), the price, the desired quantity;
The Trading BEAN software or App would verify that the trader's account either has sufficient cash (AppShares) to buy (sell) the indicated quantity. If so, the desired trade is submitted to the market. If not, the trader receives an error message indicating the reason the trade was not accepted.

A method comprising: receiving by a computing device, a revenue sharing offering from a provider of a computer executable module sold at retail, the revenue sharing offering comprising a description of the computer executable module, an identification of the provider of the module and a revenue sharing percentage relating to retail sales of the module; displaying, over a network, the revenue sharing offering to a plurality of investors; receiving, over the network, a plurality of bids for the revenue sharing offering, each bid comprising a respective identification of one of the plurality of investors, and a respective bid amount; selecting, by the computing device, at least one of the plurality of bids; transferring, by the computing device, from the respective investor associated with the selected at least one bid of the plurality of bids to the provider of the module, the respective bid amount; and establishing, by the computing device, a revenue sharing arrangement between the provider of the module and the selected at least one bidder, such that the selected at least one bidder receives an amount equal to the revenue sharing percentage for each retail sale of the computer executable module.

A non-transitory computer-readable media for computer executable instructions for a method comprising: receiving a revenue sharing offering from a provider of a computer executable module sold at retail, the revenue sharing offering comprising a description of the computer executable module, an identification of the provider of the module and a revenue sharing percentage relating to retail sales of the module; displaying the revenue sharing offering to a plurality of investors; receiving a plurality of bids for the revenue sharing offering, each bid comprising a respective identification of one of the plurality of investors, and a respective bid amount; selecting at least one of the plurality of bids; transferring from the respective investor associated with the selected at least one bid of the plurality of bids to the provider of the module, the respective bid amount; and establishing a revenue sharing arrangement between the provider of the module and the selected at least one bidder, such that the selected at least one bidder receives an amount equal to the revenue sharing percentage for each retail sale of the computer executable module.

The non-transitory computer-readable media further comprising: receiving, by the computing device, from the selected at least one investor, an offer to sell the revenue sharing arrangement; displaying, over a network, the offer to sell the revenue sharing arrangement to at least one buyer; receiving, over the network, from the at least one buyer, an offer to buy the revenue sharing arrangement at an offer price; receiving, over the network, from the selected at least one investor, an acceptance of the offer to buy the revenue sharing arrangement at the offer price; transferring, by the computing device, the offer price from the at least one buyer to the selected at least one investor; and transferring, by the computing device, the revenue sharing arrangement from the selected at least one bidder to the at least one buyer, such that the at least one buyer receives an amount equal to the revenue sharing percentage for each retail sale of the computer executable module occurring after the transfer of the revenue sharing arrangement from the selected at least one bidder to the at least one buyer.

The non-transitory computer-readable media wherein the amount of retail sales of the computer executable module by the provider of the computer executable module is determined for each of a plurality of periods, wherein a respective revenue sharing amount is calculated for each of the plurality of periods and is transferred from the provider of the computer executable module to the at least one selected bidder at a respective time after the end of the respective period.

A system comprising: at least one processor; computer readable media storing computer executable instructions for execution by the at least one processor comprising: logic executed by the processor for providing a primary market that allows a company to sell a percentage of the revenue of a product of the company to an investor, wherein the percentage of revenue stake in the product comprises issued shares; issuing shares entitling the investor holding the issued shares to a percentage of revenues generated by sales of the product underlying the issued shares; logic executed by the processor for auctioning the issued shares to the investor at a first price; transferring the issued shares from the company to the investor in exchange for financial capital equivalent to the first price multiplied by a number of issued shares transferred; logic executed by the processor for providing a secondary market for providing liquidity to the issued shares that allows the investor to trade the issued shares at a second price; logic executed by the processor for establishing a custodian for maintaining ownership of records identifying the investor holding the issued shares purchased at the first price or the second price; logic executed by the processor for distributing the percentage of revenues generated by sales of the product to the custodian for safe keeping until a dividend is distributed; and logic executed by the processor for distributing the dividend to the investor holding the issued shares from the custodian based on a number of the issued shares held by the investor, wherein the transfer of the issued shares from the company to the investor provides financial capital for the company without relinquishing an ownership stake in the company itself; and wherein the issued shares traded at the second price provides a price signal for an efficient allocation of capital.

All patents, patent applications, and published references cited herein are hereby incorporated by reference in their entirety. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method comprising:
receiving by a computing device, a revenue sharing offering from a provider of a computer executable module sold at retail, the revenue sharing offering comprising a description of the computer executable module, an identification of the provider of the module and a revenue sharing percentage relating to retail sales of the module;
displaying, over a network, the revenue sharing offering to a plurality of investors;
receiving, over the network, a plurality of bids for the revenue sharing offering, each bid comprising a respective identification of one of the plurality of investors, and a respective bid amount;
selecting, by the computing device, at least one of the plurality of bids;
transferring, by the computing device, from the respective investor associated with the selected at least one bid of the plurality of bids to the provider of the module, the respective bid amount; and
establishing, by the computing device, a revenue sharing arrangement between the provider of the module and the selected at least one bidder, such that the selected at least one bidder receives an amount equal to the revenue sharing percentage for each retail sale of the computer executable module.

2. The method of claim 1 further comprising:
transferring, by the computing device, from the respective investor associated with the selected at least one bid of the plurality of bids to the provider of an electronic exchange, a commission amount relating to the establishment of the revenue sharing arrangement.

3. The method of claim 1 further comprising:
transferring, by the computing device, from the provider of the computer executable model to the provider of an electronic exchange, a commission amount relating to the establishment of the revenue sharing arrangement.

4. The method of claim 1 further comprising:
receiving, by the computing device, from the selected at least one investor, an offer to sell the revenue sharing arrangement;
displaying, over a network, the offer to sell the revenue sharing arrangement to at least one buyer;
receiving, over the network, from the at least one buyer, an offer to buy the revenue sharing arrangement at an offer price;
receiving, over the network, from the selected at least one investor, an acceptance of the offer to buy the revenue sharing arrangement at the offer price;
transferring, by the computing device, the offer price from the at least one buyer to the selected at least one investor; and
transferring, by the computing device, the revenue sharing arrangement from the selected at least one bidder to the at least one buyer, such that the at least one buyer receives an amount equal to the revenue sharing percentage for each retail sale of the computer executable module occurring after the transfer of the revenue sharing arrangement from the selected at least one bidder to the at least one buyer.

5. The method of claim 1 further comprising:
transferring, by the computing device, from the respective investor associated with the selected at least one bid of the plurality of bids to the provider of an electronic exchange, a commission amount relating to the transfer of the revenue sharing arrangement.

6. The method of claim 1 further comprising:
transferring, by the computing device, from the provider of the computer executable module to the provider of an electronic exchange, a commission amount relating to the transfer of the revenue sharing arrangement.

7. The method of claim 1 further comprising:
determining, by the computing device, an amount of retail sales of the computer executable module by the provider of the computer executable module;
calculating, by the computing device, a revenue sharing amount using the revenue sharing percentage and the amount of retail sales; and
transferring, by the computing device, the revenue sharing amount from the provider of the computer executable module to the at least one selected bidder.

8. The method of claim 7 wherein the amount of retail sales of the computer executable module by the provider of the computer executable module is determined for each of a plurality of periods, wherein a respective revenue sharing amount is calculated for each of the plurality of periods and is transferred from the provider of the computer executable module to the at least one selected bidder at a respective time after the end of the respective period.

9. The method of claim 1 wherein the revenue sharing arrangement comprises a plurality of issued shares, such that each of the plurality of issued shares is individually transferrable to a buyer.

10. The method of claim 1 wherein the respective bid amount comprises a quantity of issued shares and a bid price.

11. The method of claim 9 further comprising:
aggregating, by the computing device, the plurality of issued shares into a bundle, such that the bundle is individually transferrable to the at least one buyer.

12. The method of claim 11 wherein the bundle comprises issued shares relating to a plurality of revenue sharing arrangements, each of the plurality of revenue sharing arrangements relating to one of a plurality of computer executable modules.

13. The method of claim 12 wherein at least some of the plurality of revenue sharing arrangements relate to a first provider and at least some of the plurality of revenue sharing arrangements relate to a second provider.

14. The method of claim 1 wherein the revenue sharing offering is displayed to the plurality of investors for a predefined period, wherein the plurality of bids for the revenue sharing offering is received during the predefined period, and wherein the each bid of the plurality of bids is not visible to any of the plurality of investors other than the investor making the respective bid, and wherein the selected at least one plurality of bids is selected at the close of the predefined period.

15. The method of claim 1 wherein at least one plurality of bids having a lowest bid price is automatically selected.

16. The method of claim 15 wherein the identification of each of the plurality of investors is not provided to the provider of the computer executable module.

17. A non-transitory computer-readable media for computer executable instructions for a method comprising:
receiving a revenue sharing offering from a provider of a computer executable module sold at retail, the revenue sharing offering comprising a description of the computer executable module, an identification of the provider of the module and a revenue sharing percentage relating to retail sales of the module;
displaying the revenue sharing offering to a plurality of investors;
receiving a plurality of bids for the revenue sharing offering, each bid comprising a respective identification of one of the plurality of investors, and a respective bid amount;
selecting at least one of the plurality of bids;
transferring from the respective investor associated with the selected at least one bid of the plurality of bids to the provider of the module, the respective bid amount; and
establishing a revenue sharing arrangement between the provider of the module and the selected at least one bidder, such that the selected at least one bidder receives an amount equal to the revenue sharing percentage for each retail sale of the computer executable module.

18. The non-transitory computer-readable media of claim 17 further comprising:
receiving, by the computing device, from the selected at least one investor, an offer to sell the revenue sharing arrangement;
displaying, over a network, the offer to sell the revenue sharing arrangement to at least one buyer;
receiving, over the network, from the at least one buyer, an offer to buy the revenue sharing arrangement at an offer price;
receiving, over the network, from the selected at least one investor, an acceptance of the offer to buy the revenue sharing arrangement at the offer price;
transferring, by the computing device, the offer price from the at least one buyer to the selected at least one investor; and
transferring, by the computing device, the revenue sharing arrangement from the selected at least one bidder to the at least one buyer, such that the at least one buyer receives an amount equal to the revenue sharing percentage for each retail sale of the computer executable module occurring after the transfer of the revenue sharing arrangement from the selected at least one bidder to the at least one buyer.

19. The non-transitory computer-readable media of claim 18 wherein the amount of retail sales of the computer executable module by the provider of the computer executable module is determined for each of a plurality of periods, wherein a respective revenue sharing amount is calculated for each of the plurality of periods and is transferred from the provider of the computer executable module to the at least one selected bidder at a respective time after the end of the respective period.

20. A system comprising:
at least one processor;
computer readable media storing computer executable instructions for execution by the at least one processor comprising:
logic executed by the processor for providing a primary market that allows a company to sell a percentage of the revenue of a product of the company to an investor, wherein the percentage of revenue stake in the product comprises issued shares; issuing shares entitling the investor holding the issued shares to a percentage of revenues generated by sales of the product underlying the issued shares;
logic executed by the processor for auctioning the issued shares to the investor at a first price; transferring the issued shares from the company to the investor in exchange for financial capital equivalent to the first price multiplied by a number of issued shares transferred;
logic executed by the processor for providing a secondary market for providing liquidity to the issued shares that allows the investor to trade the issued shares at a second price;
logic executed by the processor for establishing a custodian for maintaining ownership of records identifying the investor holding the issued shares purchased at the first price or the second price;
logic executed by the processor for distributing the percentage of revenues generated by sales of the product to the custodian for safe keeping until a dividend is distributed; and
logic executed by the processor for distributing the dividend to the investor holding the issued shares from the custodian based on a number of the issued shares held by the investor, wherein the transfer of the issued shares from the company to the investor provides financial capital for the company without relinquishing an ownership stake in the company itself; and wherein the issued shares traded at the second price provides a price signal for an efficient allocation of capital.
